(19) United States
(12) Patent Application Publication
(10) Pub. No.: US 2025/0190174 A1
(43) Pub. Date: Jun. 12, 2025

(54) Overcoming Memory, Bandwidth, and/or Power Constraints in a Processing-In-Memory Architecture

(71) Applicant: Google LLC, Mountain View, CA (US)

(72) Inventors: Hongil Yoon, San Jose, CA (US); Wenzhi Cui, Mountain View, CA (US); Sai Srivatsa Bhamidipati, Mountain View, CA (US); Hee Jun Park, San Diego, CA (US)

(73) Assignee: Google LLC, Mountain View, CA (US)

(21) Appl. No.: 18/977,586

(22) Filed: Dec. 11, 2024

Related U.S. Application Data
(60) Provisional application No. 63/609,263, filed on Dec. 12, 2023.

(51) Int. Cl. G06F 7/544; G06F 17/16; G06N 3/063

(52) U.S. Cl. CPC G06F 7/5443; G06F 17/16; G06N 3/063

(57) ABSTRACT

Techniques and apparatuses are described for overcoming memory, bandwidth, and/or power constraints in a processing-in-memory architecture. Example techniques include on-the-fly type conversion and/or sparsity support. On-the-fly type conversion converts data of a first numerical data type to a second numerical data type that matches an expected numerical data type of a logic circuit of a memory device. With on-the-fly type conversion, the memory device can conserve memory and realize a higher effective internal bandwidth while having a flexible design that can support a variety of different memory architectures and/or different machine-learned models. With sparsity support, the processing-in-memory can avoid performing operations that involve data having values equal to zero to conserve power. Also, sparsity support can increase an effective bandwidth for transferring data and conserve memory. With the described techniques, the memory device can utilize processing-in-memory to perform larger and more complex operations for implementing features associated with artificial intelligence.

### RELATED APPLICATION(S)

This application claims the benefit of U.S. Provisional Patent Application Ser. No. 63/609,263, filed on Dec. 12, 2023, the disclosure of which is incorporated by reference herein in its entirety.

### BACKGROUND

With the emergence of artificial general intelligence (AGI) and generative artificial intelligence (GAI) technologies, computing devices can provide a wide range of services for a user. Many computing devices implement some form of artificial intelligence using a machine-learned model, such as a large-language model (LLM). To perform higher complexity tasks, a machine-learned model may require additional memory, bandwidth, and/or power, which can strain a computing device's available resources. As limitations on available space and power can significantly impact the utilization of artificial intelligence, there is an increased demand for designing computing devices that can support larger and more complex machine-learned models within given size and/or power constraints.

### SUMMARY

Techniques and apparatuses are described that overcome memory, bandwidth, and/or power constraints in a processing-in-memory architecture. Example techniques include on-the-fly type conversion and/or sparsity support. On-the-fly type conversion converts data of a first numerical data type to a second numerical data type that matches an expected numerical data type of a logic circuit of a memory device. With on-the-fly type conversion, the memory device can conserve memory and realize a higher effective internal bandwidth while having a flexible design that can support a variety of different memory architectures and/or different machine-learned models. With sparsity support, the processing-in-memory can avoid performing operations that involve data having values equal to zero to conserve power. Also, sparsity support can increase an effective bandwidth for transferring data and can conserve memory within the memory device. With the described techniques, the memory device can utilize processing-in-memory to perform larger and more complex operations for implementing features associated with artificial intelligence.

Aspects described below include a method performed by a memory device for overcoming memory, bandwidth, and/or power constraints in a processing-in-memory architecture. The method includes performing, using multiplication-accumulation units of the memory device, processing-in-memory to implement at least a portion of a machine-learned model. The performing comprises storing, within the memory device, weights associated with the machine-learned model. The stored weights have a first numerical data type. The performing also comprises generating converted weights by converting the weights from the first numerical data type to an expected input data type associated with the multiplication-accumulation units. The performing further comprises passing the converted weights as inputs to the multiplication-accumulation units.

Aspects described below include another method performed by a memory device for overcoming memory, bandwidth, and/or power constraints in a processing-in-memory architecture. The method includes performing, using multiplication-accumulation units of the memory device, processing-in-memory to implement at least a portion of a machine-learned model. The performing comprises performing input-based sparsity handling and/or weight-based sparsity handling. The input-based sparsity handling causes operations performed by the multiplication-accumulation units to be bypassed based on a data element of input data having a value equal to zero. The weight-based sparsity handling causes an operation performed by a multiplication-accumulation unit of the multiplication-accumulation units to be bypassed based on a corresponding weight having a value equal to zero. The corresponding weight is associated with the machine-learned model.

Aspects described below also include a memory device comprising a memory array with at least one bank. The at least one bank is configured to store weights associated with a machine-learned model. The weights have a first numerical data type. The memory device also comprises at least one logic circuit, which is coupled to the at least one bank and comprises multiplication-accumulation units. The logic circuit is configured to perform, using the multiplication-accumulation units, processing-in-memory to implement at least a portion of the machine-learned model. The memory device also includes one or more of the following: at least one type converter, at least one zero-activation skipping filter, or at least one weight-based sparsity filter. The at least one type converter is configured to generate converted weights by converting the weights from the first numerical data type to an expected input data type associated with the multiplication-accumulation units. The at least one zero-activation skipping filter is coupled to the at least one logic circuit and is configured to perform input-based sparsity handling to cause operations performed by the multiplication-accumulation units to be bypassed based on a data element of input data having a value equal to zero. The at least one weight-based sparsity filter is coupled between the memory array and the multiplication-accumulation units and is configured to perform weight-based sparsity handling to cause an operation performed by a multiplication-accumulation unit to be bypassed based on a corresponding weight having a value equal to zero.

Aspects described below also include a system with means for overcoming memory, bandwidth, and/or power constraints in processing-in-memory architecture.

### BRIEF DESCRIPTION OF DRAWINGS

Apparatuses for and techniques for overcoming memory, bandwidth, and/or power constraints in processing-in-memory architecture are described with reference to the following drawings. The same numbers are used throughout the drawings to reference like features and components:

FIG. 1 illustrates an example environment in which techniques for processing-in-memory can be implemented;

FIG. 2 illustrates an example implementation of a computing device with a memory device that can perform processing-in-memory;

FIG. 3 illustrates example communications between a host device and a memory device;

FIG. 4 illustrates example components of a memory device for transferring data to support processing-in-memory;

FIG. 5 illustrates an example relationship between a type converter, a sparsity handler, and other components of a memory device;

FIG. 6 illustrates example operations for performing on-the-fly type conversion;

FIG. 7-1 illustrates an example operation of a zero-activation skipping filter for overcoming memory, bandwidth, and/or power constraints in a processing-in-memory architecture;

FIG. 7-2 illustrates an example scheme for performing sparsity support using a zero-activation skipping filter;

FIG. 8 illustrates example operations for performing sparsity support using a data compressor;

FIG. 9 illustrates an example scheme for storing compressed weights and sparsity maps within a memory array;

FIG. 10 illustrates example operations for conserving power using a power optimization circuit;

FIG. 11 illustrates an example method for overcoming memory, bandwidth, and/or power constraints in a processing-in-memory architecture;

FIG. 12 illustrates an example method for performing on-the-fly type conversion;

FIG. 13 illustrates an example method for performing input-based sparsity handling;

FIG. 14 illustrates an example method for performing weight-based sparsity handling; and

FIG. 15 illustrates an example computing system embodying, or in which techniques may be implemented that overcome memory, bandwidth, and/or power constraints in a processing-in-memory architecture.

### DETAILED DESCRIPTION

As limitations on available space and power in computing devices can significantly impact the utilization of artificial intelligence, there is an increased demand for designing computing devices that can support larger and more complex machine-learned (ML) models. Some computing devices utilize a technique known as processing-in-memory (PIM), which enables computing functions to be performed within a memory device, thereby reducing the amount of memory transfers that occur between the memory device and other components within the computing device. Although processing-in-memory can help overcome memory transfer bandwidth limitations, this may not be sufficient for larger and more complex machine-learned models. Furthermore, processing-in-memory does not necessarily address memory capacity constraints and limited power availability within the computing device.

To address these issues, techniques are described for overcoming memory, bandwidth, and/or power constraints in a processing-in-memory architecture. Example techniques include on-the-fly type conversion and sparsity support, which can be used separately or in combination. On-the-fly type conversion is performed within a memory device on data that is passed as an input to a logic circuit that performs processing-in-memory. In particular, the on-the-fly type conversion converts data of a first numerical data type to a second numerical data type that matches an expected numerical data type of the logic circuit. With on-the-fly type conversion, data, such as weights of a machine-learned model, can be stored in the memory device using a numerical data type that conserves memory, such as a lower precision data type that utilizes fewer bits compared to the expected numerical data type of the logic circuit. In addition to conserving memory, the lower precision data type enables the memory device to realize a higher effective internal bandwidth in transferring the data to the logic circuit. Furthermore, the on-the-fly type conversion provides additional design flexibility by enabling the logic circuit to support a variety of different types of memory-device designs and/or different types of machine-learned models.

With sparsity support, the processing-in-memory can avoid performing operations that use data having values equal to zero to conserve power. Examples types of sparsity support include input-based sparsity handling and weight-based sparsity handling. Input-based sparsity handling is performed based on input data to the machine-learned model and can effectively improve bandwidth efficiency for transferring data. Weight-based sparsity handling is performed based on parameters of the machine-learned model and can conserve memory within the memory device and can enable the memory device to realize a higher effective internal bandwidth in transferring data. With the described techniques of on-the-fly type conversion and/or sparsity support, the memory device can utilize processing-in-memory to perform larger and more-complex operations for implementing features associated with artificial intelligence.

### Operating Environment

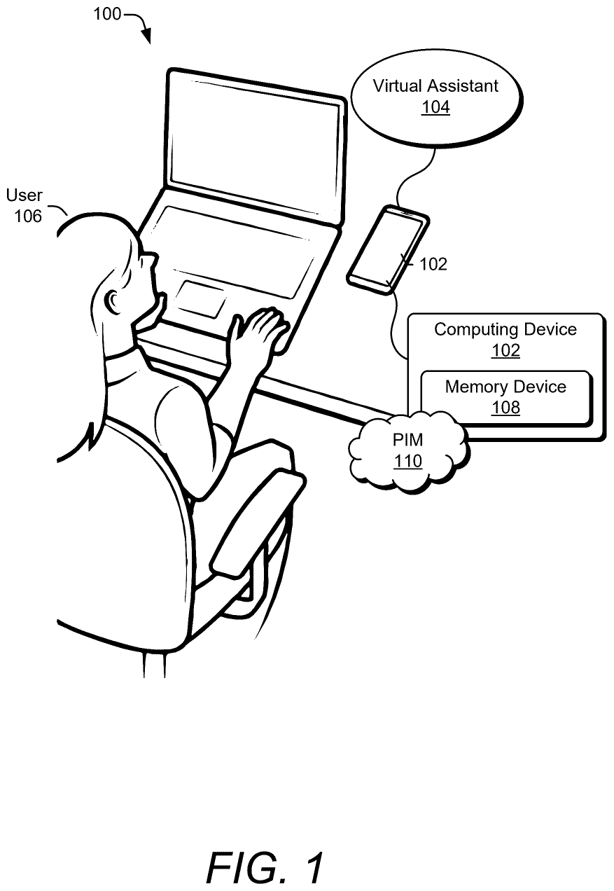

FIG. 1 is an illustration of an example environment 100 in which techniques utilizing processing-in-memory can be implemented. In the environment 100, a computing device 102 executes an application that provides a virtual assistant 104 (e.g., a voice-assistant service or a personal agent). Through voice commands, a user 106 can interact with the virtual assistant 104 to activate certain features of the computing device 102. In this manner, the virtual assistant 104 can provide hands-free control of the computing device 102. The virtual assistant 104 can also communicate information to the user 106 through the computing device 102's speakers and/or display.

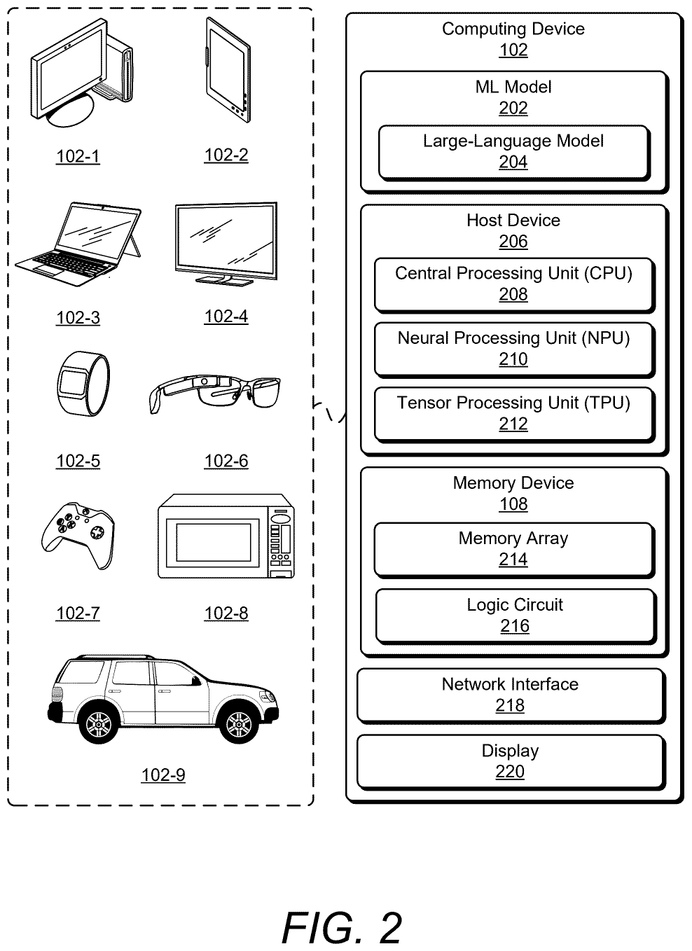

The virtual assistant 104 can be implemented using a machine-learned model, such as a large-language model. The computing device 102 includes a memory device 108 that supports processing-in-memory 110 (PIM 110) to implement at least a portion of the machine-learned model. The processing-in-memory 110 enables computing functions to be performed within the memory device 108, thereby reducing an amount of memory transfers that occur between the memory device 108 and another component of the computing device 102 with processing capabilities. The computing device 102 is further described with respect to FIG. 2.

FIG. 2 illustrates an example computing device 102. The computing device 102 is illustrated with various non-limiting example devices including a desktop computer 102-1, a tablet 102-2, a laptop 102-3, a television 102-4, a computing watch 102-5, computing glasses 102-6, a gaming system 102-7, a microwave 102-8, and a vehicle 102-9. Other devices may also be used, such as a home service device, a smart speaker, a smart thermostat, a baby monitor, a Wi-Fi® router, a drone, a trackpad, a drawing pad, a netbook, an e-reader, a home automation and control system, a wall display, and another home appliance. Note that the computing device 102 can be wearable, non-wearable but mobile, or relatively immobile (e.g., desktops and appliances).

The computing device 102 is designed to provide one or more features associated with artificial intelligence (AI), such as the virtual assistant 104 of FIG. 1. To provide these features, the computing device 102 can implement a machine-learned model 202 (ML model 202). The machine-learned model 202 includes one or more neural networks. A neural network includes a group of connected nodes (e.g., neurons or perceptrons), which are organized into one or more layers. As an example, the machine-learned model 202 includes a deep neural network with an input layer, an output layer, and one or more hidden layers positioned between the input layer and the output layer. The nodes of the deep neural network can be partially-connected or fully-connected between the layers.

In some implementations, the neural network is a recurrent neural network (e.g., a long short-term memory (LSTM) neural network) with connections between nodes forming a cycle to retain information from a previous portion of an input data sequence for a subsequent portion of the input data sequence. In other cases, the neural network is a feed-forward neural network in which the connections between the nodes do not form a cycle. Additionally or alternatively, the machine-learned model 202 includes another type of neural network, such as a convolutional neural network. The machine-learned model 202 can also include one or more types of regression models and/or classification models. Example regression models include a single linear regression model, multiple linear regression models, logistic regression models, step-wise regression models, multi-variate adaptive regression splines, locally estimated scatterplot smoothing models. Example classification models include a binary classification model, a multi-class classification model, or a multi-label classification model.

In general, the machine-learned model 202 is trained using supervised or unsupervised learning to analyze data. The supervised learning can use simulated (e.g., synthetic) data or measured (e.g., real) data for training purposes. Outputs of the machine-learned model 202 can be passed to an application that is running on the computing device 102, can be passed to another component of the computing device 102, and/or can be presented by the computing device 102 to the user 106. In some implementations, the machine-learned model 202 is implemented as a large-language model (LLM) 204. Example large-language models include LaMDA GLM, Chat GPT, Gopher, Chinchilla, Gemini, or PaLM.

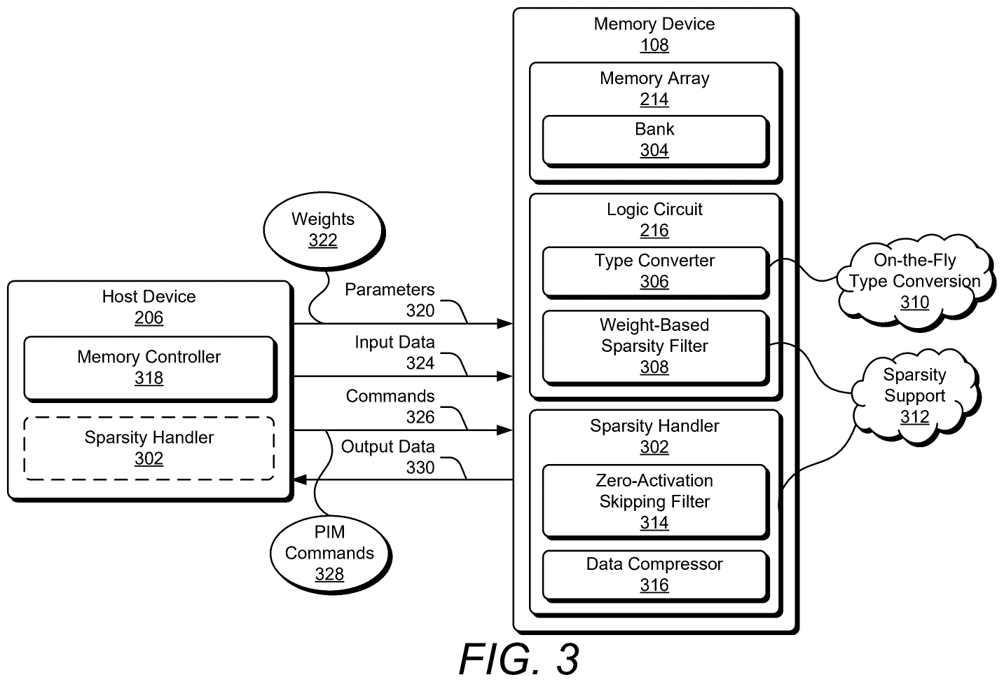

The computing device 102 includes at least one host device 206 and at least one memory device 108. The host device 206 can pass data to the memory device 108 for processing. This data can represent an input to the machine-learned model 202. The host device 206 can include at least one processor, at least one computer-readable storage medium, and a memory controller, which is further described with respect to FIG. 3. In example implementations, the host device 206 implements a central processing unit (CPU) 208, a neural processing unit (NPU) 210, a tensor processing unit (TPU) 212, or an artificial-intelligence accelerator. Other example implementations are also possible in which the host device 206 implements an image signal processor (ISP), a digital signal processor (DSP), a graphics processing unit (GPU), and the like. The host device 206 can be implemented on a system-on-chip (SoC).

The memory device 108, which can also be realized with a memory module, can include a dynamic random-access memory (DRAM) die or module (e.g., Low-Power Double Data Rate synchronous DRAM (LPDDR SDRAM)). The DRAM die or module can include a three-dimensional (3D) stacked DRAM device, which may be a high-bandwidth memory (HBM) device or a hybrid memory cube (HMC) device. The memory device 108 can operate as a main memory or an auxiliary memory of the computing device 102.

The memory device 108 includes at least one memory array 214 and at least one logic circuit 216. The memory array 214 can include an array of memory cells, including but not limited to memory cells of DRAM, SDRAM, three-dimensional (3D) stacked DRAM, DDR memory, LPDDR SDRAM, and so forth. With the memory array 214, the memory device 108 can store various types of data that enable the memory device 108 to implement at least a portion of the machine-learned model 202. The logic circuit 216 performs aspects of processing-in-memory 110. The logic circuit 216 can also be referred to as a compute unit or a processing-in-memory computation unit. In general, the logic circuit 216 can perform some or all of the operations associated with running the machine-learned model 202. For example, the logic circuit 216 can perform multiplication operations, accumulation operations, and/or activation functions (e.g., a hyperbolic tangent (tanh) function, a rectified linear unit (ReLU) activation function, or a gaussian error linear unit (GeLU) activation function).

Computer engineers may implement the host device 206 and the various memories in multiple manners. In some cases, the host device 206 and the memory device 108 can be disposed on, or physically supported by, a printed circuit board (e.g., a rigid or flexible motherboard). The host device 206 and the memory device 108 may additionally be integrated together on an integrated circuit or fabricated on separate integrated circuits and packaged together. In the examples described herein, the memory device 108 implements at least a portion of the machine-learned model 202 using processing-in-memory 110. This means that the memory device 108 performs one or more operations associated with the machine-learned model 202. Various implementations are also possible in which the memory device 108 implements an entirety of the machine-learned model 202, or the memory device 108 and the host device 206 implement different portions of the machine-learned model 202.

The computing device 102 can also include a network interface 218 for communicating data over wired, wireless, or optical networks. For example, the network interface 218 may communicate data over a local-area-network (LAN), a wireless local-area-network (WLAN), a personal-area-network (PAN), a wide-area-network (WAN), an intranet, the Internet, a peer-to-peer network, point-to-point network, a mesh network, Bluetooth®, and the like. The computing device 102 may also include the display 220. The host device 206 and the memory device 108 are further described with respect to FIG. 3.

FIG. 3 illustrates example communications between the host device 206 and the memory device 108. In the depicted configuration, the memory device 108 includes the memory array 214, the logic circuit 216, and a sparsity handler 302. Using the memory array 214, the memory device 108 stores information for implementing at least a portion of the machine-learned model 202. The memory array 214 can include at least one bank 304. For implementations of the memory array 214 that include multiple banks 304, the multiple banks 304 can be organized in different bank groups, different ranks, and/or different channels.

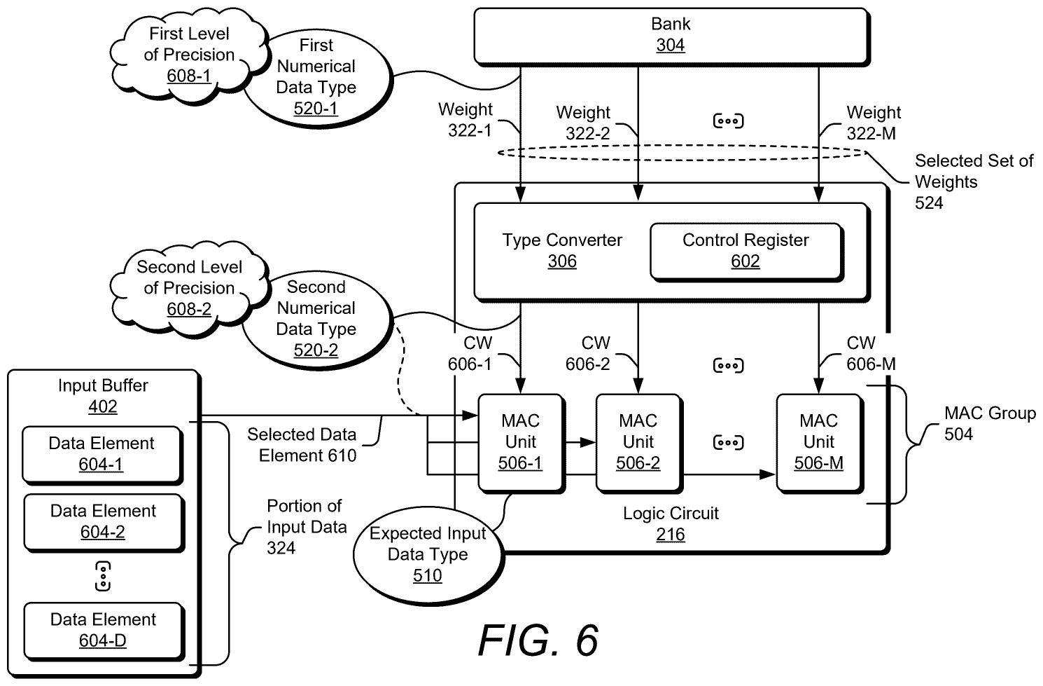

The logic circuit 216 performs multiplication operations, accumulation operations, and/or activation functions to implement at least a portion of the machine-learned model 202. The logic circuit 216 can optionally include at least one type converter 306 and/or at least one weight-based sparsity filter 308. The type converter 306 performs on-the-fly type conversion 310 to ensure data that is processed by the logic circuit 216 has a numerical data type that matches an expected numerical data type for downstream operations. With on-the-fly type conversion 310, data can be stored in the memory array 214 using a numerical data type that conserves memory, such as a lower precision data type that utilizes fewer bits compared to the expected numerical data type associated with the logic circuit 216. In addition to conserving memory, the lower precision data type enables the memory device 108 to realize a higher effective internal bandwidth in transferring the data from the memory array 214 to the logic circuit 216. Furthermore, on-the-fly type conversion 310 provides flexibility by enabling the logic circuit 216 to readily adapt to a variety of different numerical data types that are implemented based on various memory-device architectures or various machine-learned models 202. As such, the logic circuit 216 can be readily integrated into different memory devices 108 or can support different types of machine-learned models 202 without having to be redesigned. Example operations for performing on-the-fly type conversion 310 using the type converter 306 are further described with respect to FIG. 6.

The weight-based sparsity filter 308 and the sparsity handler 302 perform aspects of sparsity support 312 to assist with overcoming memory, bandwidth, and/or power constraints associated with processing-in-memory 110. Sparsity support 312 involves handling data with values equal to zero. In general, sparsity support 312 enables operations performed via processing-in-memory 110 to be skipped over (e.g., ignored or bypassed) if the operations involve data having values equal to zero and would otherwise result in outputs having values equal to zero. By skipping these operations, the memory device 108 can conserve power by performing fewer computations.

In a first example, sparsity support 312 is applied to data that represents inputs to the machine-learned model 202. This type of sparsity support 312 is referred to as input-based sparsity handling. To perform input-based sparsity handling, the sparsity handler 302 includes at least one zero-activation skipping filter 314. With input-based sparsity handling, the computing device 102 can realize a higher bandwidth efficiency for communicating inputs for processing-in-memory 110. Example operations for performing input-based sparsity handling using the zero-activation skipping filter 314 are further described with respect to FIGS. 7-1 and 7-2.

In a second example, sparsity support 312 is applied to data that represents weights of the machine-learned model 202. This type of sparsity support 312 is referred to as weight-based sparsity handling. To perform weight-based sparsity handling, the logic circuit 216 includes the weight-based sparsity filter 308 and the sparsity handler 302 includes at least one data compressor 316. With the data compressor 316, data associated with the weights can be stored in a compressed manner within the memory array 214 to conserve memory. The compressed weights also enable the memory device 108 to realize a higher effective internal bandwidth in transferring the compressed weights from the memory array 214 to the logic circuit 216.

In various implementations, the computing device 102 can be designed to support input-based sparsity handling, weight-based sparsity handling, or a combination thereof. In the example depicted in FIG. 3, the memory device 108 includes the necessary components for performing input-based sparsity handling and/or weight-based sparsity handling. Other implementations are also possible in which the sparsity handler 302 (or a portion of the sparsity handler 302, such as the zero-activation skipping filter 314 or the data compressor 316) is implemented on the host device 206 instead of the memory device 108. In a first example case in which the host device 206 includes the zero-activation skipping filter 314, the host device 206 can perform aspects input-based sparsity handling. In a second example case in which the host device 206 includes the data compressor 316, the host device 206 and the memory device 108 operate together to perform weight-based sparsity handling. In general, various combinations of the zero-activation skipping filter 314 and/or the data compressor 316 can be implemented on the host device 206 or the memory device 108. With the described techniques of on-the-fly type conversion 310 and/or sparsity support 312, the memory device 108 can utilize processing-in-memory 110 to perform larger and more complex operations for implementing features associated with artificial intelligence.

The host device 206 includes at least one memory controller 318. The memory controller 318 provides a high-level or logical interface between a processor of the host device 206 (not shown) and the memory device 108. The memory controller 318 can be realized with any of a variety of suitable memory controllers (e.g., a double-data-rate (DDR) memory controller 318 that can process requests for data stored on the memory device 108). Although not explicitly shown, the host device 206 can include a physical interface (PHY) that transfers data between the memory controller 318 and the memory device 108 through an interconnect.

During initialization, the host device 206 transmits parameters 320 to the memory device 108. The parameters 320 specify characteristics of the machine-learned model 202, which can include weights 322, biases, kernel sizes or parameters, activation functions, and stride/pooling configurations. The parameters 320 can also identify nodes that are utilized or layers that are skipped. The memory device 108 stores the weights 322 in the memory array 214. Other implementations are also possible in which the memory device 108 is pre-programmed with the weights 322 in a different manner.

The data compressor 316, which can be implemented within the host device 206 or the memory device 108, can generate a compressed version of the weights 322, which enables the weights 322 to occupy a smaller amount of memory within the memory array 214, thereby conserving memory resources of the memory device 108. If the data compressor 316 is implemented within the host device 206, the compressed version of the weights 322 can be transmitted by the host device 206 to the memory device 108. The memory array 214 stores the weights 322 for future use by the logic circuit 216. In some cases, the stored weights 322 have a numerical data type that does not match the expected numerical data type associated with the logic circuit 216. This numerical data type can be associated with a smaller quantity of bits than the expected numerical data type, which further conserves memory resources within the memory device 108.

During normal operations, the memory controller 318 of the host device 206 transmits input data 324 and commands 326 to the memory device 108. The sparsity handler 302 can filter the input data 324 using the zero-activation skipping filter 314 to remove elements of the input data 324 having values equal to zero, thereby conserving bandwidth and power resources of the memory device 108. If the zero-activation skipping filter 314 is implemented within the host device 206, the host device 206 can send the filtered version of the input data 324 to the memory device 108 to improve the bandwidth efficiency for transferring the input data 324. The commands 326 can instruct the memory device 108 to perform read and/or write operations and generally enable the memory device 108 to appropriately use the parameters 320 and the input data 324 to perform operations of the machine-learned model 202. The commands 326 can also include instructions specific for the logic circuit 216 to perform aspects of processing-in-memory 110. These instructions are referred to as PIM commands 328 and can also include information for configuring the type converter 306 and/or the weight-based sparsity filter 308.

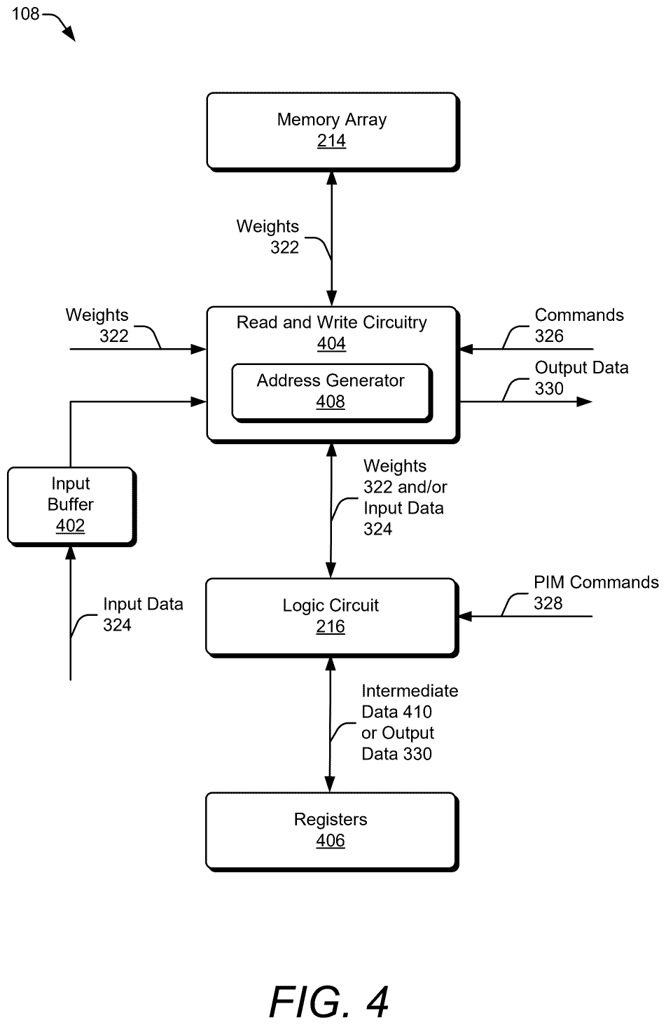

Based on the commands 326, the logic circuit 216 processes the input data 324 and the weights 322 to generate output data 330. The memory device 108 transmits the output data 330 to the host device 206. The host device 206 can pass the output data 330 to an application or present the output data 330 to the user 106. The propagation of information within the memory device 108 for performing processing-in-memory 110 is further described with respect to FIG. 4.

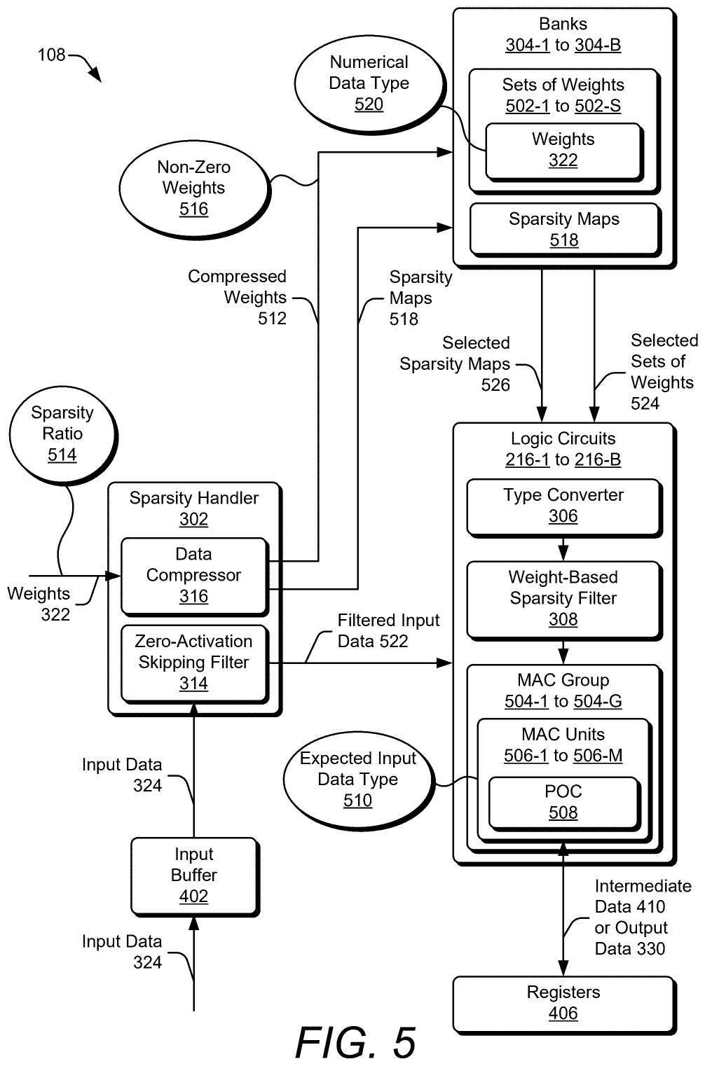

FIG. 4 illustrates example components of the memory device 108 and the propagation of information between these components. In the depicted configuration, the memory device 108 includes at least one input buffer 402, the memory array 214, read and write circuitry 404, the logic circuit 216, and multiple registers 406. Although a single logic circuit 216 is depicted in FIG. 4 for simplicity, the memory device 108 can include multiple logic circuits 216, as further described with respect to FIG. 5.

The input buffer 402 provides temporary storage of the input data 324. This temporary storage enables the zero-activation skipping filter 314 to perform aspects of the sparsity support 312, as further described with respect to FIGS. 7-1 and 7-2. In general, the input buffer 402 temporarily stores the input data 324 prior to the input data 324 being passed to the logic circuit 216. The input buffer 402 can be implemented using one or more buffers, a queue, cache memory, or multiple registers.

The read and write circuitry 404 is coupled to the input buffer 402, the memory array 214, and the logic circuit 216. In general, the read and write circuitry 404 enables the appropriate information to be passed between the input buffer 402, the memory array 214, the logic circuit 216, the registers 406, and the host device 206, as further described below. The read and write circuitry 404 can include an address generator 408, which identifies appropriate addresses that are to be accessed in the memory array 214 to support processing-in-memory 110.

The registers 406 are coupled to the logic circuit 216 and provide temporary storage for data while the logic circuit 216 performs processing-in-memory 110. A first example type of data can include intermediate data 410 generated by the logic circuit 216 during normal operations. The registers 406 can pass the intermediate data 410 back to the logic circuit 216 for further processing at a later time. A second example type of data can include the output data 330, which is eventually transferred to the host device 206.

During initialization, the read and write circuitry 404 can write the weights 322 to the memory array 214. During normal operations, the input buffer 402 stores the input data 324 that is transferred from the host device 206. The read and write circuitry 404 can read the weights 322 from the memory array 214, transfer the weights 322 to the logic circuit 216, and transfer the input data 324 from the input buffer 402 to the logic circuit 216 based on the commands 326. The logic circuit 216 performs processing-in-memory 110 based on the PIM commands 328 and based on the data that is provided by the read and write circuitry 404 and/or the registers 406. Once the logic circuit 216 generates the output data 330, the read and write circuitry 404 enables the output data 330 to be transferred to the host device 206. Other operations of the memory device 108 for implementing on-the-fly type conversion 310 and sparsity support 312 are further described with respect to FIG. 5.

FIG. 5 illustrates an example relationship between the type converter 306, the weight-based sparsity filter 308, the sparsity handler 302, and other components of the memory device 108. In the depicted configuration, the memory device 108 includes multiple banks 304-1 to 304-B and multiple logic circuits 216-1 to 216-B, where B represents a positive integer. The banks 304 can be coupled to the logic circuits 216 via the read/write circuitry 404 of FIG. 4. In this example, each logic circuit 216 is associated with a particular bank 304. Other implementations are also possible in which a logic circuit 216 is associated with two or more banks 304. The quantity of banks 304 (e.g., the variable B) can vary depending on a design of the memory device 108. In example implementations, the quantity of banks 304 is equal to a power of two, such as 8, 16, 32, or 64.

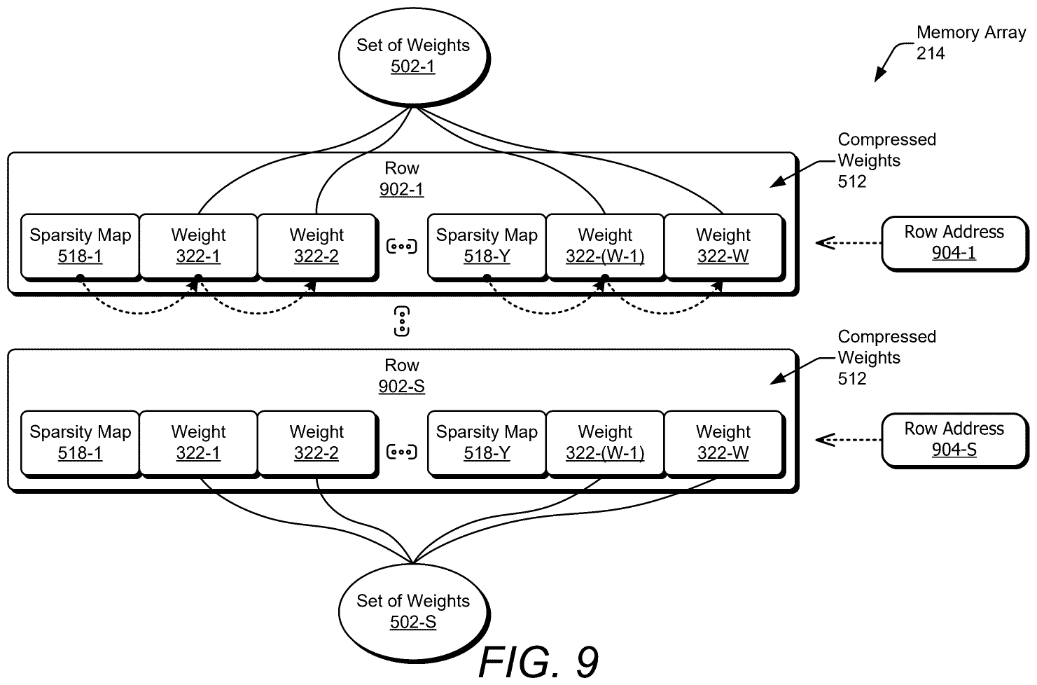

Each of the banks 304 can store multiple sets of weights 502-1 to 502-S, where S represents a positive integer that is greater than one. In an example implementation, each set of weights 502 can be used to process one element of the input data 324, as further described with respect to FIG. 6. Each set of weights 502 can be stored in at least a portion of a row within the bank 304. In some cases, the sets of weights 502 can be stored in corresponding rows of a bank 304, as shown in FIG. 9. The quantity of weights 322 associated with a given set of weights 502 can vary depending on a quantity of bits associated with each weight 322, a design of the memory device 108, and/or a design of the machine-learned model 202. In example implementations, each set of weights 502 includes a quantity of weights that is equal to a power of two (e.g., 16, 32, 64, 128, or 256).

Each of the logic circuits 214 includes the type converter 306, the weight-based sparsity filter 308, and multiplication-accumulation (MAC) groups 504-1 to 504-G (MAC groups 504-1 to 504-G), where G represents a positive integer. The weight-based sparsity filter 308 is coupled between the type converter 306 and the MAC groups 504. Although not explicitly shown in FIG. 5, each logic circuit 216 can also include other components, such as a bias circuit and an activation circuit. The bias circuit can apply a bias to data that is generated by the MAC group 504. The activation circuit can perform an activation function to the data that is generated by the MAC Group 504.

Each MAC group 504 includes multiple MAC units 506-1 to 506-M, where M represents a positive integer. In example implementations, the quantity of MAC units 506 (e.g., a value of variable M) is equal to a power of two, such as 16, 32, 64, or 128. In general, the quantity of MAC units 506 can vary depending on a design of the memory device 108 and a design of the machine-learned model 202. Each MAC unit 506 can perform a multiplication operation and/or an accumulation operation to implement a portion of the machine-learned model 202. Each MAC unit 506 can optionally include a power optimization circuit 508 (POC 508) to improve a power efficiency of the memory device 108.

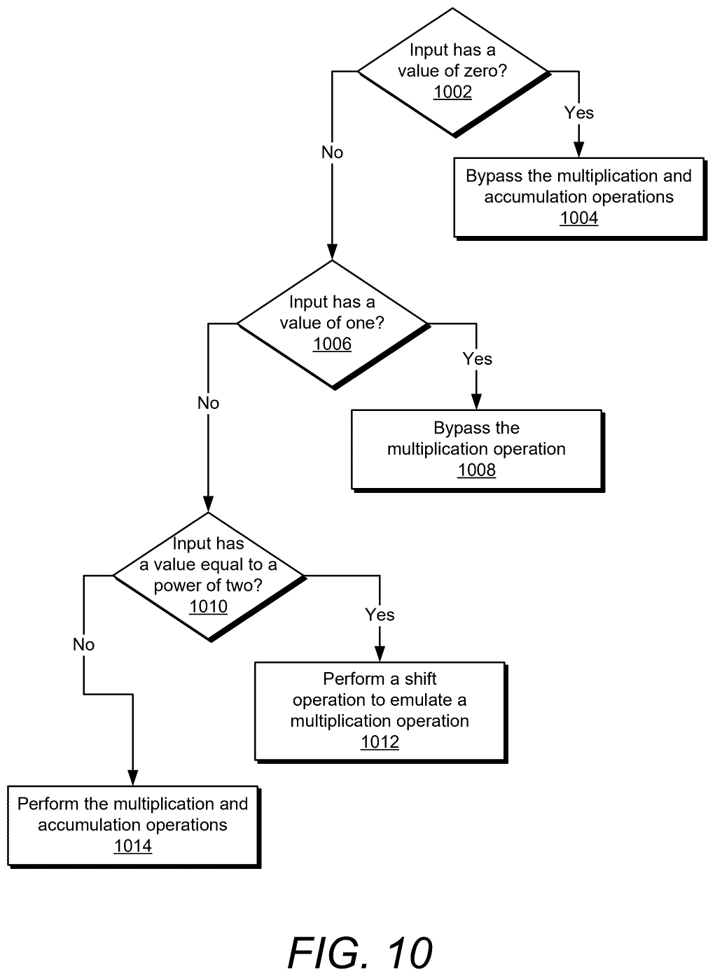

The power optimization circuit 508 enables the memory device 108 to conserve power resources by dynamically adapting which operations are performed by the MAC unit 506 based on values of inputs that are passed to the MAC unit 506. In an example, the power optimization circuit 508 can selectively cause the MAC unit 506 to bypass one or more operations (e.g., bypass the multiplication operation and/or the accumulation operation) or perform an equivalent operation that consumes less power (e.g., a shift operation) whenever possible. An example scheme implemented by the power optimization circuit 508 is further described with respect to FIG. 10.

In general, the MAC units 506 are designed to operate with inputs that have a particular numerical data type, which is represented by expected input data type 510. In some implementations, the expected input data type 510 is determined during design and manufacturing and remains fixed (e.g., cannot be changed during operations). The type converter 306 ensures that any data that is stored within the banks 304 and/or data that is provided by the host device 206 is in a format that matches the expected input data type 510.

The memory device 108 can optionally include the sparsity handler 302 to perform aspects of sparsity support 312 for overcoming memory, bandwidth, and/or power constraints in the processing-in-memory architecture. The data compressor 316 of the sparsity handler 302 is coupled between the host device 206 and the banks 304. The data compressor 316 can compress the weights 322 to conserve memory resources within the memory device 108. Although not explicitly depicted in FIG. 5, the data compressor 316 can also be coupled to the read and write circuitry 404 and provide information to the address generator 408 to enable the compressed data to be appropriately read from the banks 304 and passed to the logic circuits 216. In general, the data compressor 316 can perform data compression and facilitate selective weight reading.

The zero-activation skipping filter 314 is coupled between the input buffer 402 and the logic circuits 216. In this way, the zero-activation skipping filter 314 of the sparsity handler 302 can filter the input data 324 prior to the input data 324 being broadcasted to the logic circuits 214. This enables the memory device 108 to conserve power and improve an internal bandwidth. The zero-activation skipping filter 314 can include a decoder capable of detecting data elements within the input data 324 that have values equal to zero. In some implementations, the zero-activation skipping filter 314 can be implemented as part of a command generator within the memory device 108.

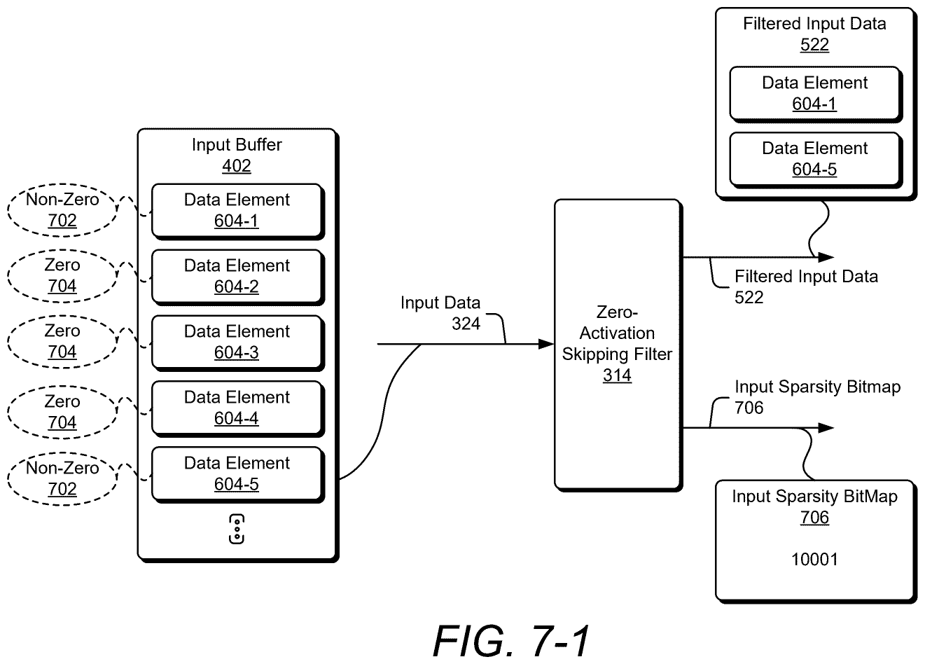

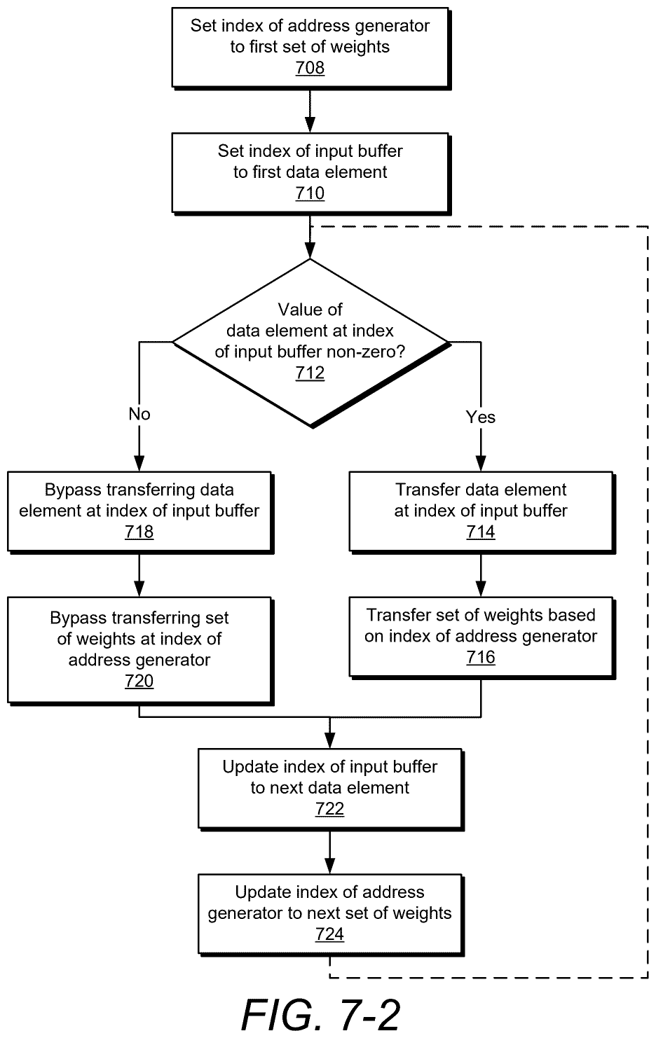

Although not explicitly shown in FIG. 5, the zero-activation skipping filter 314 is also coupled to the address generator 408 of the read and write circuitry 404. This enables the zero-activation skipping filter 314 to configure which sets of weights 502 are selected and passed to the logic circuits 216 based on a determined sparsity of the input data 324. An operation of the zero-activation skipping filter 314 is further described with respect to FIG. 7.

During initialization, the data compressor 316 of the sparsity handler 302 receives the weights 322 from the host device 206 and generates compressed weights 512 based on the sparsity ratio 514 associated with the weights 322. The compressed weights 512 include non-zero weights 516 (e.g., weights 322 that have values other than zero). The sparsity ratio 514 can be determined by the data compressor 316 and/or provided as a parameter 320 by the host device 206. Generally speaking, the sparsity ratio 514 indicates a ratio of weights with values equal to zero per a group of consecutive weights.

The data compressor 316 also generates sparsity maps 518, which identifies a sparsity pattern within the weights 322. The sparsity maps 518 enables the compressed weights 512 to be appropriately decoded by the weight-based sparsity filter 308. In some implementations, the sparsity maps 518 and the compressed weights 512 are stored in an interleaved manner within a row of a bank 304, as further described with respect to FIG. 9. The weights 322 that are stored within the banks 304 have a numerical data type 520. In example implementations, the numerical data type 520 can be a 1-bit, 2-bit, 4-bit, or 8-bit integer.

During normal operations, the zero-activation skipping filter 314 processes the input data 324 that is stored within the input buffer 402. The zero-activation skipping filter 314 generates filtered input data 522, which includes data elements having non-zero values. In other words, the data elements having values of zero are removed from the input data 324 to generate the filtered input data 522. Using the read and write circuitry 404 of FIG. 4, the sparsity handler 302 passes the filtered input data 522 to the MAC units 506-1 to 506-M. In this way, the zero-activation skipping filter 314 can improve bandwidth efficiency and conserver power by preventing the broadcasting of inputs with a zero value to the host device 206. The zero-activation skipping filter 314 also enables the read and write circuitry 404 to perform selective weight reading so that the logic circuits 216 process the filtered input data 522 using weights 322 that correspond to the filtered input data 522. In some implementations, the filtered input data 522 can be broadcasted over a bus to the MAC units 506-1 to 506-M.

Selected sets of weights 524 and selected sparsity maps 526 are also transferred from the banks 304 to the corresponding logic circuits 216 via the read and write circuitry 404. The type converter 306 performs on-the-fly type conversion 310 on a selected set of weights 524 to convert the numerical data type 520 of the selected set of weights 524 to the expected input data type 510 of the MAC units 506. The weight-based sparsity filter 308 decodes the selected sets of weights 524 using the selected sparsity map 526. To conserver power, the weight-based sparsity filter 308 can cause one or more MAC units 506 that are associated with a weight 322 having a value of zero to bypass the multiplication and accumulation operations.

The MAC units 506 of the logic circuits 216 process a data element of the filtered input data 522 using the selected set of weights 524. In some cases, the MAC units 506 generate the intermediate data 410 or the output data 330, which can be temporarily stored within the registers 406.

Other implementations are also possible in which the host device 206 implements one or more features of the sparsity handler 302. In other words, the host device 206 can implement the zero-activation skipping filter 314 and/or the data compressor 316 in some implementations. The techniques for performing on-the-fly type conversion 310 are further described with respect to FIG. 6. The techniques for performing sparsity support 312 are further described with respect to FIGS. 7-1 to 9.

### On-the-Fly Type Conversion

FIG. 6 illustrates example operations for performing on-the-fly type conversion 310 using the type converter 306. In the depicted configuration, the type converter 306 includes or has access to one or more control registers 602. Operands of the one or more control registers 602 can be written to by the host device 206 to appropriately configure the type converter 306 for performing a particular type of conversion. The operands of the one or more control registers 602 can be dynamically changed by the host device 206 based on the predetermined numerical data type 520 of the weights 322 and the expected input data type 510 of the MAC units 506.

In the examples below, the operations of the memory device 108 are described with respect to a single bank 304 and a single logic circuit 216 for simplicity. Similar operations can be performed by other banks 304 and other logic circuits 216 within the memory device 108. The logic circuit 216 is also shown to include one MAC group 504 for simplicity. Other implementations are also possible in which the logic circuit 216 includes and utilizes multiple MAC groups 504 for on-the-fly type conversion 310. In this example, the logic circuit 216 does not include the weight-based sparsity filter 308 and the memory device 108 does not include the sparsity handler 302 for performing sparsity support 312. In general, the techniques for performing on-the-fly type conversion 310 can be performed by themselves or in combination with any of the techniques for performing sparsity support 312.

During normal operations, the bank 304 stores multiple sets of weights 502-1 to 502-S, as shown in FIG. 5. The weights 322-1 to 322-M that form each set of weights 502 have a first numerical data type 520-1. The input buffer 402 stores at least a portion of the input data 324, which is provided by the host device 206. The portion of the input data 324 can include one or more data elements 604, such as data elements 604-1, 604-2 . . . 604-D, where D represents a positive integer. A value of D can depend on a storage size of the input buffer 402 and a numerical data type 520 associated with the input data 324.

The read and write circuitry 404 transfers a selected set of weights 524, which includes weights 322-1 to 322-M, from the bank 304 to the logic circuit 216. The type converter 306 performs on-the-fly type conversion 310 based on the controls specified in the operands of one or more of the control registers 602. In particular, the type converter 306 generates converted weights (CW) 606-1 to 606-M based on the weights 322-1 to 322-M, respectively. The converted weights 606 have the expected input data type 510 of the MAC units 506. In this example, the expected input data type 510 is represented by a second numerical data type 520-2, which differs from the first numerical data type 520-1. The type converter 306 can perform a variety of different conversion operations to provide flexibility in converting a variety of different first numerical data types 520-1 to a variety of different second numerical data types 520-2.

Consider an example in which the first numerical data type 520-1 is associated with a smaller quantity of bits compared to the second numerical data type 520-2. In some cases, the first numerical data type 520-1 can also be associated with a first level of precision 608-1 that is less than a second level of precision 608-2 associated with the second numerical data type 520-2. For example, the first numerical data type 520-1 can include an integer having 1, 2, 4, or 8 bits (e.g., INT1, INT2, INT4, or INT8). Also, the second numerical data type 520-2 can include an integer having 4 or 8 bits (e.g., INT4 or INT8) or a floating point having 16 bits, such as a brain floating point (e.g., BF16).

The type converter 306 passes the converted weights 606-1 to 606-M to the MAC units 506-1, 506-2 . . . 506-M, respectively. The read and write circuitry 404 also transfers at least one selected data element 610 to at least one of the MAC units 506-1 to 506-M. In this example, a single data element 604 is transferred to all of the MAC units 506-1 to 506-M within the MAC group 504. Other implementations are also possible in which multiple data elements 604 are transferred to different MAC units 506 and/or different MAC groups 504. The MAC units 506-1 to 506-M individually perform operations based on the selected data element 610 and the corresponding converted weights 606-1 to 606-M. These operations implement aspects of processing-in-memory 110 and implement at least a portion of the operations associated with the machine-learned model 202.

Performing on-the-fly type conversion 310 on the weights 322 can improve the effective internal bandwidth within the memory device 108 by a significant amount. Consider an example in which the first numerical data type 520-1 represents INT4 and the second numerical data type 520-2 represents BF16. In this case, the effective internal bandwidth improves by 400%. In another example, the effective internal bandwidth improves 200% if the first numerical data type 520-1 represents INT4 and the second numerical data type represents INT8. With a higher effective bandwidth, the memory device 108 can be designed with a logic circuit 216 that includes a larger quantity of MAC units 506 to increase computational throughput. In this way, the memory device 108 can readily implement larger and more complex machine-learned models 202.

In the examples described above, the type converter 306 performs on-the-fly type conversion 310 on the weights 322. In this situation, the selected data element 610 provided by the input buffer 402 can already be in a format associated with the second numerical data type 520-2, as indicated by the dashed line in FIG. 6. Other implementations are also possible in which the type converter 306 performs on-the-fly type conversion 310 on the input data 324 if the numerical data type of the input data 324 does not match the expected input data type 510. If the numerical data type 520 of the input data 324 is associated with fewer bits compared to the expected input data type 510, the computing device 102 can realize a higher bandwidth efficiency in transferring the input data 324 between the host device 206 and the input buffer 402 and can conserve memory space within the input buffer 402.

To perform a variety of different on-the-fly type conversion 310, the read and write circuitry 404 can perform a full-column access or a sub-column access. Also, the logic circuit 216 can utilize a single MAC group 504 to process the converted weights 606 in a single cycle or multiple MAC groups 504 to process the converted weights 606 across multiple cycles. Utilization of the full-column access or the sub-column access and utilization of a single MAC group 504 or multiple MAC groups 504 can depend on the type of conversion operation, limitations of a size of the memory array 214, and/or a design of the logic circuit 216.

With the full-column access, the read and write circuitry 404 reads all of the weights 322-1 to 322-M within the selected set of weights 524 and passes these weights 322 to the type converter 306 for conversion. In this case, the MAC units 506 can perform operations using the converted weights 606. The operations associated with reading the weights 322, performing on-the-fly type conversion 310, and performing computations using the MAC units 506 can be performed within a single cycle.

With the sub-column access, the read and write circuitry 404 reads a portion of the weights 322 within the selected set of weights 524 (e.g., half of the weights 322 within the selected set 524) and passes these weights 322 to the type converter 306. During a first cycle, for instance, the read and write circuitry 404 reads a first half of the weights 322 within the selected set of weights 524. The MAC units 506 perform a first set of operations using converted versions of the first half of the weights 322. Outputs that are generated by the MAC units 506 are stored in the registers 406. In some cases, the registers 406 for storing this intermediate data 410 is specified by the host device 206 via the control register 602. In this case, the intermediate data 410 can represent partial sums. During a second cycle, the read and write circuitry 404 reads a second half of the weights 322 within the selected set of weights 524. The MAC units 506 perform a second set of operations using converted versions of the second half of the weights 322. The data that is generated during the second cycle is combined with the intermediate data 410 that was generated during the first cycle to generate the output data 330.

Consider a first example in which the first numerical data type 520-1 represents INT1 or INT2 and the second numerical data type 520-2 represents INT4. Another case involves the first numerical data type 520-1 being an INT1 or an INT4 and the second numerical data type 520-2 being INT8. To perform on-the-fly type conversion 310 for any of these cases, the read and write circuitry 404 can perform a full-column access and the logic circuit 216 can use two MAC groups 504 to process the converted weights 606. In a second example, the first numerical data type 520-1 represents INT2 and the second numerical data type 520-2 represents INT8. In this second example, the read and write circuitry 404 performs a sub-column access and the logic circuit 216 uses multiple MAC groups 504 (e.g., two MAC groups 504) to process the converted weights 606. In a third example, the first numerical data type 520-1 and the second numerical data type 520-2 are the same. For instance, the first and second numerical data types 520-1 and 520-2 can both represent INT4 or INT8. In this third example, the read and write circuitry 404 performs a full-column access and the logic circuit 216 uses a single MAC group 504 to process the converted weights 606.

### Sparsity Support

FIG. 7-1 illustrates example operations of the zero-activation skipping filter 314 for performing aspects of sparsity support 312. During normal operations, the zero-activation skipping filter 314 accesses the input buffer 402. In this example, the input buffer 402 at least stores data elements 604-1, 604-2, 604-3, 604-4, and 604-5. The data elements 604-1 and 604-5 have non-zero values 702. The data elements 604-2, 604-2, and 604-4 have values equal to zero 704. The zero-activation skipping filter 314 identifies the data elements 604 that have non-zero values 702 and generates filtered input data 522, which includes the data elements 604 that have non-zero values 702. In this example, the filtered input data 522 includes the data elements 604-1 and 604-5. The zero-activation skipping filter 314 passes the filtered input data 522 to the logic circuit 216.

The zero-activation skipping filter 314 also generates an input sparsity bitmap 706, which represents the sparsity of the input data 324. More specifically, the input sparsity bitmap 706 represents a sparsity of the data elements 604 that are stored in the input buffer 402 and are within a search window that is analyzed by the zero-activation skipping filter 314. A size of the search window can encompass a portion of the size of the input buffer 402 (e.g., a portion of the data elements 604 stored within the input buffer 402) or can encompass an entirety of the input buffer 402 (e.g., all of the data elements 604 stored within the input buffer 402).

In this example, the search window encompasses five data elements 604 and the input sparsity bitmap 706 has values of “10001,” which indicates that the first data element 604-1 and the fifth data element 604-5 have non-zero values 702 and the data elements 604-2 to 604-4 have values equal to zero 704. The zero-activation skipping filter 314 passes the input sparsity bitmap 706 to the address generator 408. With the input sparsity bitmap 706, the address generator 408 can cause the read and write circuitry 404 to bypass reading weights 322 that correspond to data elements 604 having values equal to zero 704 and proceed with reading weights 322 that correspond to data elements 604 having non-zero values 702. With the zero-activation skipping filter 314, the memory device 108 can dynamically identify non-zero inputs and selectively read in weights that correspond to the non-zero inputs. By filtering the input data 324 that has values equal to zero 704 and by skipping the corresponding weights 322, the memory device 108 avoids performing operations that would result in a zero output, thereby conserving power. Operations of the read and write circuitry 404 and the zero-activation skipping filter 314 are further described with respect to FIG. 7-2.

FIG. 7-2 illustrates example operations for performing sparsity support 312 using a zero-activation skipping filter 314. At 708, the zero-activation skipping filter 314 sets an index of the address generator 408 to a first set of weights 502-1. In this way, the read and write circuitry 404 is initialized and configured to read the first set of weights 502-1 that is stored in the bank 304 on a next read-type command 326. At 710, the zero-activation skipping filter 314 also sets an index of the input buffer 402 to a first data element 604-1. In this way, the read and write circuitry 404 is initialized and configured to read the first data element 604-1 that is stored in the input buffer 402 on a next read-type command 326.

At 712, the zero-activation skipping filter 314 determines if the data element 604 (e.g., a selected data element 610) at a current index of the input buffer 402 has a non-zero value 702. If the value of the data element 604 is equal to a non-zero value 702, the zero-activation skipping filter 314 causes the indexed data element 604 to be transferred to the logic circuit 216 as part of the filtered input data 522 of FIG. 5, as indicated at 714. Also, the zero-activation skipping filter 314 causes the indexed set of weights 502 to be transferred to the logic circuit 216 as part of the selected set of weights 524, as indicated at 716. Alternatively, if the data element 604 at the current index of the input buffer 402 has a value equal to zero 704, the process continues at 718.

At 718 and 720, the zero-activation skipping filter 314 causes the indexed data element 604 and the indexed set of weights 502 to be bypassed. In other words, the zero-activation skipping filter 314 causes the read and write circuitry 404 to not transfer the indexed data element 604 and causes the read and write circuitry 404 to not read the indexed set of weights 502.

At 722, the zero-activation skipping filter 314 causes the index of the input buffer 402 to be updated to point to a next data element 604 (e.g., the second data element 604-2 of FIG. 6). At 718, the zero-activation skipping filter 314 causes the index of the address generator 408 to be updated to point to a next set of weights 502 (e.g., a second set of weights 502). This process can continue for additional data elements 604 that are stored within the input buffer 402 and can continue for additional sets of weights 502 that are stored within a bank 304.

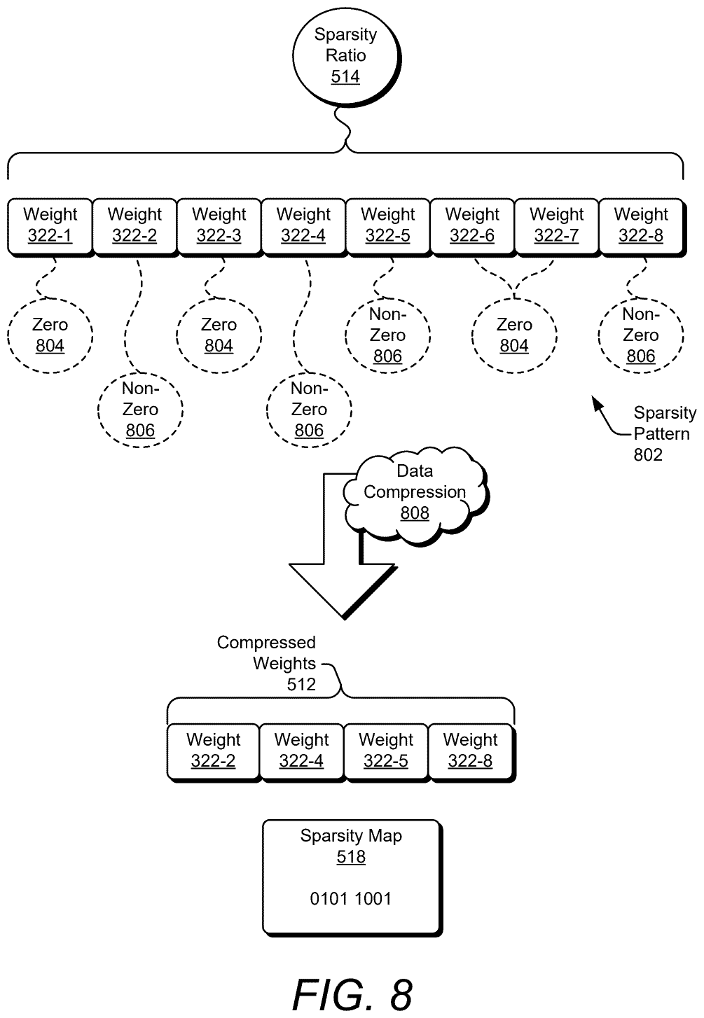

FIG. 8 illustrates example operations for performing sparsity support 312 using the data compressor 316. During training of the machine-learned model 202, the weights 322 are designed to have a particular sparsity ratio 514. The sparsity ratio 514 indicates a uniform sparsity pattern 802 that is built into the weights 322 during training to reduce a dimension of the data that is processed by the machine-learned model 202.

Sparsity ratios 514 can be generally represented by the expression K:N, where K represents the quantity of weights 322 having a zero value for every N consecutive weights 322. A first example sparsity ratio 514 can be represented by 2:4, which means there are two weights 322 having zero values for each group of four weights 322.

In this example, the weights 322-1, 322-3, 322-6, and 322-7 have values that are equal to zero 804, and the weights 322-2, 322-4, 322-5, and 322-8 have values that are equal to non-zero values 806. This satisfies the sparsity ratio 514 of 2:4 because two out of the four consecutive weights 322 have values equal to zero 804.

During initialization, the data compressor 316 performs data compression 808 to generate compressed weights 512, which include only the non-zero weights 516. The data compressor 316 also generates at least one sparsity map 518 to indicate the sparsity encoding associated with the compressed weights 512. The sparsity map 518 identifies the sparsity pattern 802 observed within the weights 322. More specifically, the sparsity map 518 indicates the pattern of non-zero weights 516 and zero-valued weights within at least a portion of the weights 322. In some cases, the data compressor 316 can generate multiple sparsity maps 518, which correspond to multiple subsets within a set of weights 502. In an example implementation, each sparsity map 518 can identify the sparsity pattern 802 observed across four consecutive weights 322. In this case, the sparsity map 518 identifies the sparsity patter 802 observed across the eight weights 322-1 to 322-8 and includes bits “0101 1001” to indicate the non-zero weights 516 and the weights 322 with values equal to zero.

By storing the compressed weights 512 instead of all of the weights 322, the memory device 108 can conserve a significant amount of memory. The decreased size of the compressed weights 512 also enables the memory device 108 to improve internal bandwidth efficiency in transferring the compressed weights 512 from the memory array 214 to the logic circuit 216. Furthermore, the weight-based sparsity filter 308 can utilize the sparsity map 518 to cause the logic circuit 216 to bypass operations that would otherwise be performed using the weights 322 that have values equal to zero 804, which conserves power. The storage of the sparsity maps 518 and the compressed weights 512 can be further tailored to reduce row-switching overhead, as further described with respect to FIG. 9.

FIG. 9 illustrates an example scheme for storing compressed weights 512 and sparsity maps 518 within the memory array 214. In the depicted configuration, the memory array 214 is shown to include rows 902-1 to 902-S. Each row 902 can be accessed using a row address 904. The row 902-1 is associated with a row address 904-1, and the row 904-S is associated with a row address 904-S. Although not explicitly shown in FIG. 9, the rows 902-1 to 902-S can correspond to a particular bank 304 within the memory array 214.

Each row 902 stores weights 322-1, 322-2 . . . 322-(W−1), and 322-W, where W represents a positive integer that is less than M. These weights 322 represent the compressed weights 512 and therefore include the non-zero weights 516. The weights 322 stored within each row 902 form a set of weights 502. For example, the weights 322 within the row 902-1 form the set of weights 502-1, and the weights 322 within the row 902-S form the set of weights 502-S.

Each row 902 also stores sparsity maps 518-1 to 518-Y, where Y represents a positive integer that is less than W. The sparsity maps 518 describe the sparsity pattern 802 for a particular subset of the set of weights 502. In this example, there is a 2:1 ratio of weights 322 to a sparsity map 518. To reduce row-switching overhead, the sparsity maps 518 and corresponding subset of weights 322 are stored in an interleaved manner within the row 902. For the 2:1 ratio, columns associated with each row 902 store a sparsity map 518 and are adjacent to columns that store two corresponding non-zero weights 516. In this way, the memory device 108 can readily access the sparsity map 518 and its corresponding non-zero weights 516 within the same row 902.

### Power Optimization

FIG. 10 illustrates example operations for conserving power using the power optimization circuit 508. Consider an example situation in which the MAC unit 506 is configured, based on a PIM command 328, to perform multiplication and accumulation operations. At 1002, the power optimization circuit 508 determines if an input has a value equal to zero. The input can represent a data element 604 of the input data 324 or a weight 322 associated with the selected set of weights 524. If the input does have a value equal to zero, the power optimization circuit 508 causes the MAC unit 506 to bypass (e.g., skip) the multiplication and accumulation operations, as described at 1004. In this case, the power optimization circuit 508 causes the MAC unit 506 to ignore the PIM command 328 entirely. In various designs, the MAC unit 506 can take no further action or can output a zero to subsequent down-stream components within the logic circuit 216. By skipping the multiplication and accumulation operations, the power optimization circuit 508 enables the memory device 108 to conserve power. Alternatively, if the input has a value that is not equal to zero, the process proceeds to 1006.

At 1006, the power optimization circuit 508 determines if the input has a value equal to one. If the input does have a value equal to one, the power optimization circuit 508 causes the MAC unit 506 to bypass the multiplication operation, as described at 1008. In this case, the MAC unit 506 can partially ignore the PIM command 328 by skipping the multiplication operation and performing the accumulation operation. By skipping the multiplication operation, the power optimization circuit 508 enables the memory device 108 to conserve power. Alternatively, if the input has a value that is not equal to one, the process proceeds to 1010.

At 1010, the power optimization circuit 508 determines if the input has a value that is equal to a power of two. If the input has a value that is a power of two, the power optimization circuit 508 causes the MAC unit 506 to perform a shift operation to emulate a multiplication operation 1012. In this case, the power optimization circuit 508 causes the MAC unit 506 to ignore the multiplication operation specified by the PIM command 328 and instead perform an equivalent shift operation. The shift operation can be performed in a manner that consumes less power than the multiplication operation. By performing the shift operation instead of the multiplication operation, the power optimization circuit 508 enables the memory device 108 to conserve power. Alternatively, if the input does not have a value that is a power of two, the process proceeds to 1014.

At 1014, the power optimization circuit 508 causes the MAC unit 506 to perform the multiplication and accumulation operations. In this case, the input is such that the power optimization circuit 508 is unable bypass an operation or substitute a power-efficient operation for the multiplication and/or accumulation operations. As such, the MAC unit 506 operates in accordance with the PIM command 328.

### Example Methods

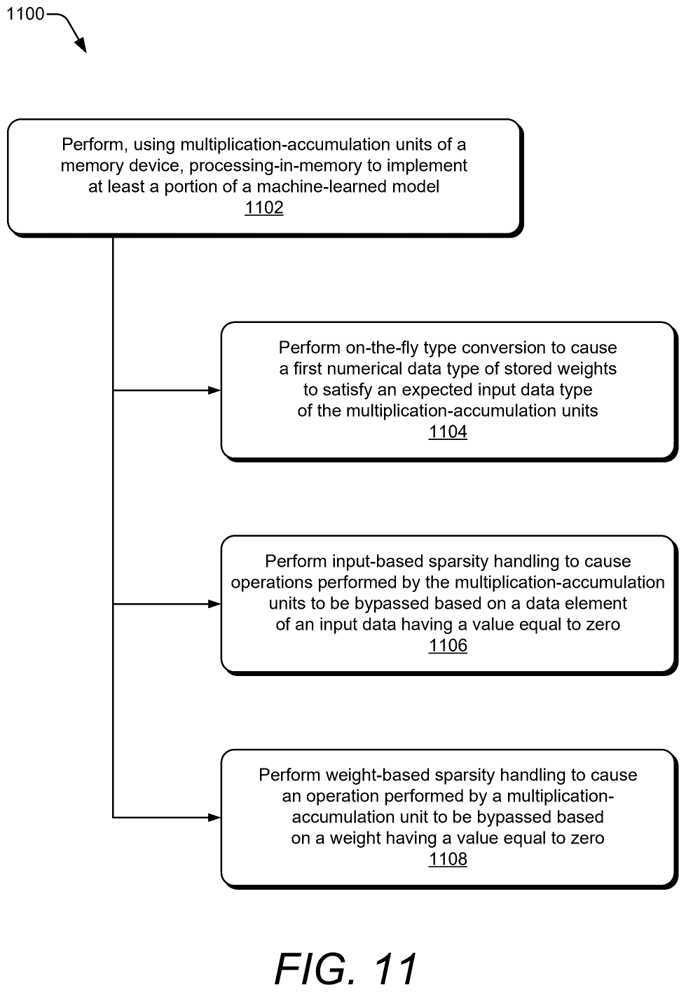

FIGS. 11, 12, 13, and 14 depict example methods 1100, 1200, 1300, and 1400 for implementing aspects of overcoming memory, bandwidth, and/or power constraints in a processing-in-memory architecture. Methods 1100 to 1400 are shown as sets of operations (or acts) performed but not necessarily limited to the order or combinations in which the operations are shown herein. Further, any of one or more of the operations may be repeated, combined, reorganized, or linked to provide a wide array of additional and/or alternate methods. In portions of the following discussion, reference may be made to the environment 100 of FIG. 1, and entities detailed in FIGS. 2 to 5, reference to which is made for example only. The techniques are not limited to performance by one entity or multiple entities operating on one device.

At 1102 in FIG. 11, processing-in-memory is performed using multiplication-accumulation units of a memory device to implement at least a portion of a machine-learned model. For example, the logic circuit 216 of FIG. 5 uses MAC units 506-1 to 506-M to perform processing-in-memory 110 and implement at least a portion of the machine-learned model 202. In some examples, the machine-learned model 202 can be implemented as a large-language model 204. In order to perform the processing-in-memory, the memory device 108 can also perform any one or more of the steps described at 1104, 1106, and 1108.

At 1104, on-the-fly type conversion is performed to cause a first numerical data type of stored weights to be converted to a second numerical data type that satisfies an expected input data type of the multiplication-accumulation units. For example, the type converter 306 performs on-the-fly type conversion 310 to cause a first numerical data type 520-1 of the weights 322 that are stored in a bank 304 to be converted to a second numerical data type 520-2 that satisfies the expected input data type 510 of the MAC units 506, as shown in FIG. 6.

At 1106, input-based sparsity handling is performed to cause operations performed by the multiplication-accumulation units to be bypassed based on a data element of an input data having a value equal to zero. For example, the zero-activation skipping filter 314 performs input-based sparsity handling to cause operations performed by the multiplication-accumulation units to be bypassed based on a data element 604 of the input data 324 having a value equal to zero. These operations can be bypassed by causing the read and write circuitry 404 to bypass transferring the data element 604 and the corresponding set of weights 502, as described with respect to FIG. 7. By bypassing these operations, the memory device 108 can conserve power by performing fewer computations.

At 1108, weight-based sparsity handling is performed to cause an operation performed by a multiplication-accumulation unit to be bypassed based on a weight having a value equal to zero. For example, the weight-based sparsity filter 308 causes an operation performed by a MAC unit 506 to be bypassed based on a weight having a value equal to zero. By bypassing this operation, the memory device 108 can conserve power by performing fewer computations. Weight-based sparsity handling can also include performing data compression 808 using the data compressor 316 so that the weights 322 can be stored as compressed weights 512. The compressed weights 512 enable the memory device 108 to conserve memory within the memory array 214.

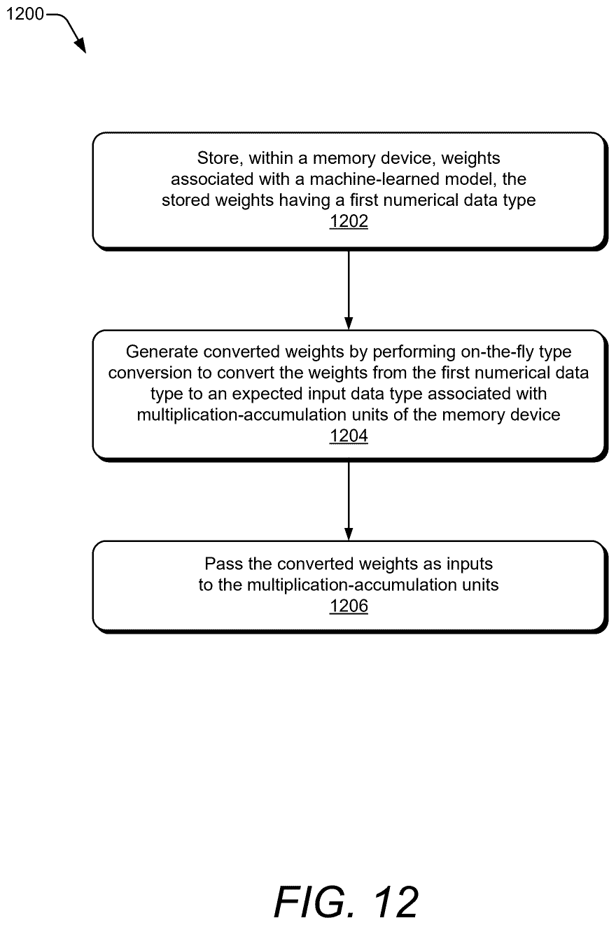

The method 1200 of FIG. 12 describes operations for performing on-the-fly type conversion 310. At 1202 in FIG. 12, weights associated with a machine-learned model are stored within a memory device. The stored weights have a first numerical data type. For example, the memory array 214 stores the weights 322 associated with the machine-learned model 202. The weights have a first numerical data type 520-1, as shown in FIG. 6.

At 1204, converted weights are generated by performing on-the-fly type conversion to convert the weights from the first numerical data type to an expected input data type associated with multiplication-accumulation units of the memory device. For example, the type converter 306 of the logic circuit 216 performs on-the-fly type conversion 310 to convert the weights 322 from the first numerical data type 520-1 to a second numerical data type 520-2 that satisfies (e.g., matches) the expected input data type 510 associated with the MAC units 506 of the memory device 108.

At 1206, the converted weights are passed as inputs to the multiplication-accumulation units. For example, the type converter 306 passes the converted weights 606 as inputs to the multiplication-accumulation units 506.

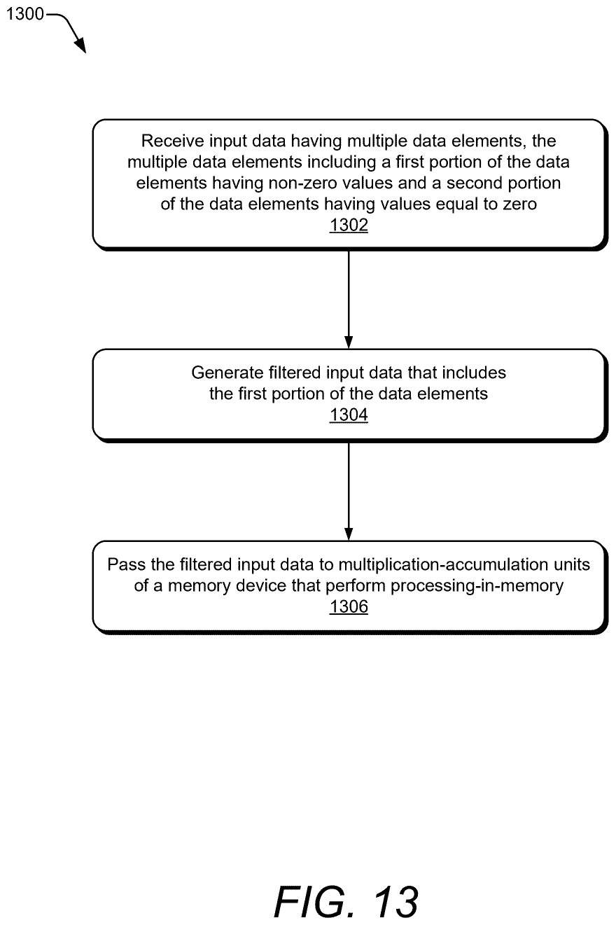

The method 1300 of FIG. 13 describes operations for performing input-based sparsity handling. At 1302, input data having multiple data element is received. The multiple data elements include a first portion of the data elements having non-zero values and a second portion of the data elements having values equal to zero. For example, the zero-activation skipping filter 314 receives the input data 324 having multiple data elements 604, as shown in FIG. 5. A first portion of the data elements 604 have non-zero values and a second portion of the data elements 604 have values equal to zero.

At 1304, filtered input data that includes the first portion of the data elements is generated. For example, the zero-activation skipping filter 314 generates filtered input data 522 that includes the first portion of the data elements 604.

At 1306, the filtered input data is passed to multiplication-accumulation units of a memory device that perform processing-in-memory. For example the zero-activation skipping filter 314 passes the filtered input data 522 to the MAC units 506 of the memory device 108. The MAC units 506 perform processing-in-memory 110. In some implementations, each data element 604 of the input data 324 can be sequentially broadcasted to the MAC units 506.

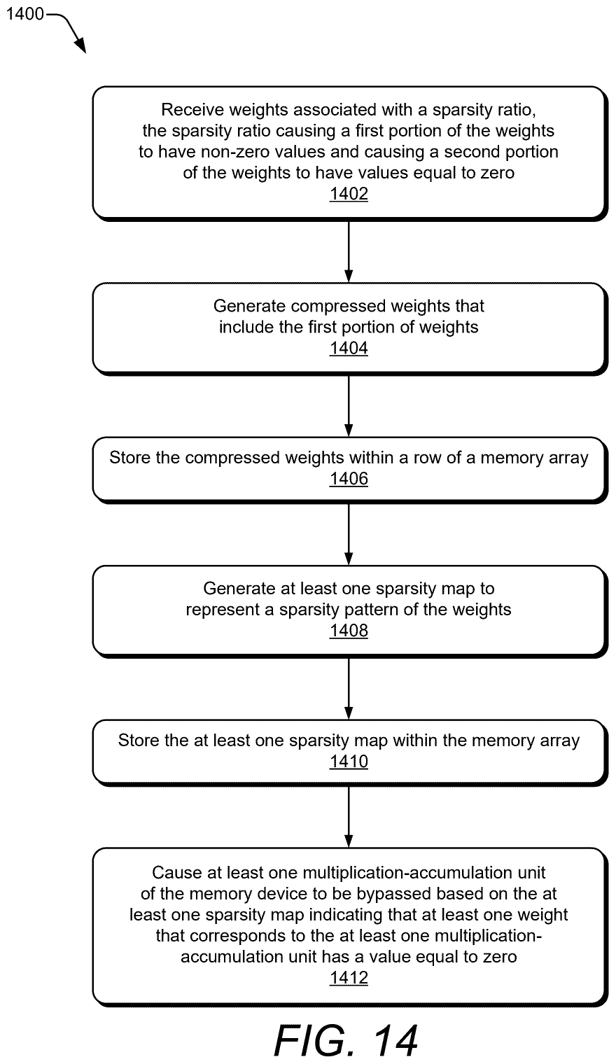

The method 1400 of FIG. 14 describes operations for performing weight-based sparsity handling. At 1402, weights associated with a sparsity ratio are received. The sparsity ratio causes a first portion of the weights to have non-zero values and causes a second portion of the weights to have values equal to zero. For example, the data compressor 316 receives the weights 322, which are associated with the sparsity ratio 514, as shown in FIG. 5. The sparsity ratio 514 causes a first portion of the weights 322 to have non-zero values 806 and causes a second portion of the weights to have values equal to zero 804, as shown in FIG. 8.

At 1404, compressed weights that include the first portion of weights are generated. For example, the data compressor 316 generates the compressed weights 512, which includes the first portion of weights 322 (e.g., the non-zero weights 516).

At 1406, the compressed weights are stored within a row of a memory array. For example, the memory array 214 stores the compressed weights 512 within a row 902, as shown in FIG. 9.

At 1408, at least one sparsity map is generated. The sparsity map represents a sparsity pattern of the weights. For example, the data compressor 316 generates at least one sparsity map 518, which represents the sparsity pattern 802 of the weights 322, as shown in FIG. 8. In some implementations, the data compressor 316 generates multiple sparsity maps 518, which correspond to different groups of weights within the first portion of weights 322.

At 1410, the at least one sparsity map is stored within the memory array. For example, the memory array 214 stores the at least one sparsity map 518. In some implementations, multiple sparsity maps 518 can be interleaved with the compressed weights 512 in a same row of the memory array 214, as shown in FIG. 9.

At 1412, at least one multiplication-accumulation unit of the memory device is bypassed based on the at least one sparsity map indicating that at least one weight that corresponds to the at least one multiplication-accumulation unit has a value equal to zero. For example, the weight-based sparsity filter 308 causes at least one of the MAC units 506 to be bypassed based on a selected sparsity map 526 indicating that a weight 322 that corresponds to the MAC unit 506 has a value equal to zero. In this way, the memory device 108 avoids performing unnecessary operations that result in a zero output value thereby conserving power.

### Example Computing System

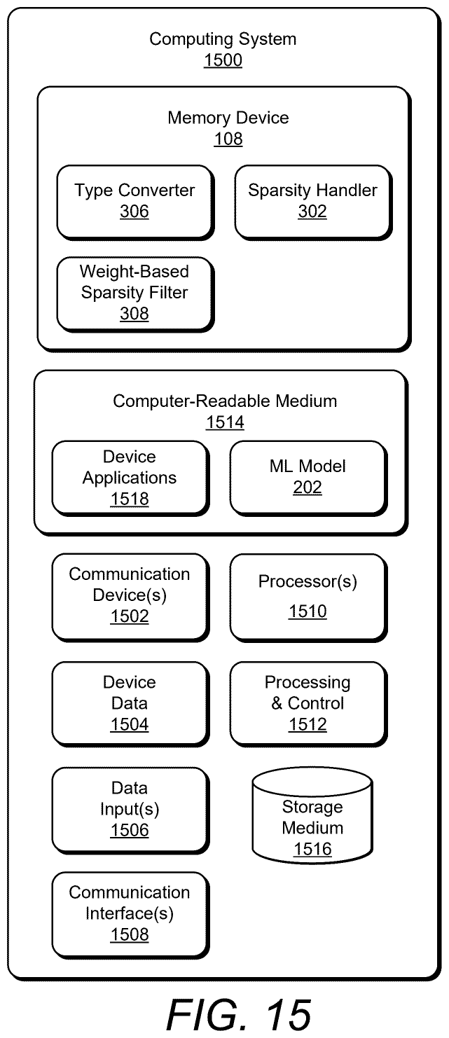

FIG. 15 illustrates various components of an example computing system 1500 that can be implemented as any type of client, server, and/or computing device as described with reference to the previous FIGS. 2 and 3 to implement aspects of overcoming memory, bandwidth, and/or power constraints in a processing-in-memory architecture.

The computing system 1500 includes communication devices 1502 that enable wired and/or wireless communication of device data 1504 (e.g., received data, data that is being received, data scheduled for broadcast, or data packets of the data). The device data 1504 or other device content can include configuration settings of the device, media content stored on the device, and/or information associated with a user of the device. Media content stored on the computing system 1500 can include any type of audio, video, and/or image data. The computing system 1500 includes one or more data inputs 1506 via which any type of data, media content, and/or inputs can be received, such as human utterances, user-selectable inputs (explicit or implicit), messages, music, television media content, recorded video content, sensor data (e.g., radar data or ultrasound data), and any other type of audio, video, and/or image data received from any content and/or data source.

The computing system 1500 also includes communication interfaces 1508, which can be implemented as any one or more of a serial and/or parallel interface, a wireless interface, any type of network interface, a modem, and as any other type of communication interface. The communication interfaces 1508 provide a connection and/or communication links between the computing system 1500 and a communication network by which other electronic, computing, and communication devices communicate data with the computing system 1500.

The computing system 1500 includes one or more processors 1510 (e.g., any of microprocessors, controllers, and the like), which process various computer-executable instructions to control the operation of the computing system 1500. Alternatively or in addition, the computing system 1500 can be implemented with any one or combination of hardware, firmware, or fixed logic circuitry that is implemented in connection with processing and control circuits which are generally identified at 1512. Although not shown, the computing system 1500 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The computing system 1500 also includes a computer-readable medium 1514, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. The disk storage device may be implemented as any type of magnetic or optical storage device, such as a hard disk drive, a recordable and/or rewriteable compact disc (CD), any type of a digital versatile disc (DVD), and the like. The computing system 1500 can also include a mass storage medium device (storage medium) 1516.

The computer-readable medium 1514 provides data storage mechanisms to store the device data 1504, as well as various device applications 1518 and any other types of information and/or data related to operational aspects of the computing system 1500. For example, an operating system 1520 can be maintained as a computer application with the computer-readable medium 1514 and executed on the processors 1510. The device applications 1518 may include a device manager, such as any form of a control application, software application, signal-processing and control module, code that is native to a particular device, a hardware abstraction layer for a particular device, and so on.

In this example, the computer-readable medium 1514 can store information associated with the machine-learned model 202 of FIG. 2. The processor 1510 and/or the computer-readable medium 1514 can implement the host device 206 of FIG. 2. The computing system 1500 also includes at least one memory device 108, which can utilize processing-in-memory 110 to implement at least a portion of the machine-learned model 202. Explained another way, the processing-in-memory 110 enables the memory device 108 to perform at least some of the operations associated with the machine-learned model 202.

The memory device 108 includes any system components, engines, managers, software, firmware, and/or hardware to implement techniques for overcoming memory, bandwidth, and/or power constraints in a processing-in-memory architecture. In particular, the memory device 108 includes at least one type converter 306, at least one sparsity handler 302, at least one weight-based sparsity filter 308, or some combination thereof.

### CONCLUSION

Although techniques for overcoming memory, bandwidth, and/or power constraints in a processing-in-memory architecture have been described in language specific to features and/or methods, it is to be understood that the subject of the appended claims is not necessarily limited to the specific features or methods described. Rather, the specific features and methods are disclosed as example implementations of overcoming memory, bandwidth, and/or power constraints in a processing-in-memory architecture.

Some Examples are described below.

Example 1: A method performed by a memory device, the method comprising:
performing, using multiplication-accumulation units of the memory device, processing-in-memory to implement at least a portion of a machine-learned model, the performing comprising:
   storing, within the memory device, weights associated with the machine-learned model, the stored weights having a first numerical data type;
   generating converted weights by converting the weights from the first numerical data type to an expected input data type associated with the multiplication-accumulation units; and
   passing the converted weights as inputs to the multiplication-accumulation units.

Example 2: The method of example 1, wherein:
the first numerical data type is associated with a first quantity of bits; and
the expected input data type is associated with a second quantity of bits that is greater than the first quantity of bits.

Example 3: The method of example 1 or 2, wherein:
the first numerical data type is associated with a first level of precision; and
the expected input data type is associated with a second level of precision that is greater than the first level of precision.

Example 4: The method any previous example, wherein the performing of the processing-in-memory further comprises:
passing input data to the multiplication-accumulation units, the input data representing at least one input of the machine-learned model, the input data having a second numerical data type that matches the expected input data type associated with the multiplication-accumulation units.

Example 5: The method of any previous example, wherein:
the weights are associated with a sparsity ratio, the sparsity ratio causing a first portion of the weights to have non-zero values and causing a second portion of the weights to have values equal to zero;
the storing comprises storing a set of the weights within a row of a memory array of the memory device; and
the method further comprises:
   generating compressed weights that include the first portion of weights;
   storing the compressed weights as the set of weights within the row;
   generating at least one sparsity map to represent a sparsity pattern of the weights; and
   storing the at least one sparsity map within the memory array.

Example 6: The method of example 5, wherein the storing of the at least one sparsity map comprises storing the at least one sparsity map in the same row as the set of weights.

Example 7: The method of example 6, wherein:
the generating of the at least one sparsity map comprises generating multiple sparsity maps to represent the sparsity pattern within multiple groups of the weights; and
the storing of the at least one sparsity map comprises storing the multiple sparsity maps and the set of the weights in a manner that arranges each sparsity map to occupy columns that are adjacent to columns that store the compressed weights corresponding to the sparsity map.

Example 8: The method of any one of examples 5 to 7, further comprising:
causing at least one of the multiplication-accumulation units to be bypassed based on the at least one sparsity map indicating that at least one weight that corresponds to the at least one of the multiplication-accumulation units has a value equal to zero.

Example 9: A method performed by a memory device, the method comprising:
performing, using multiplication-accumulation units of the memory device, processing-in-memory to implement at least a portion of a machine-learned model, the performing comprising at least one of the following:
   performing input-based sparsity handling to cause operations performed by the multiplication-accumulation units to be bypassed based on a data element of input data having a value equal to zero; or
   performing weight-based sparsity handling to cause an operation performed by a multiplication-accumulation unit of the multiplication-accumulation units to be bypassed based on a corresponding weight having a value equal to zero, the corresponding weight associated with the machine-learned model.

Example 10: The method of example 9, wherein:
the performing of the processing-in-memory comprises performing the input-based sparsity handling; and
the performing of the input-based sparsity handling comprises:
   receiving, by a zero-activation skipping filter of the memory device, the input data having multiple data elements, the multiple data elements including a first portion of data elements having non-zero values and a second portion of the data elements having values equal to zero;
   generating filtered input data that includes the first portion of the data elements; and
   passing the filtered input data to multiplication-accumulation units of the memory device.

Example 11: The method of example 9 or 10, wherein:
the performing of the processing-in-memory comprises performing the weight-based sparsity handling; and
the performing of the weight-based sparsity handling comprises:
   receiving, by a data compressor of the memory device, weights associated with the machine-learned model, the weights having a sparsity ratio that causes a first portion of the weights to have non-zero values and causes a second portion of the weights to have values equal to zero;
   generating, by the data compressor, compressed weights that include the first portion of weights;
   storing the compressed weights within a row of a memory array of the memory device;
   generating, by the data compressor, at least one sparsity map to represent a sparsity pattern of the weights; and
   storing the at least one sparsity map within the memory array.

Example 12: The method of example 11, wherein the storing of the at least one sparsity map comprises storing the at least one sparsity map in the same row as the compressed weights.

Example 13: The method of example 12, wherein:
the generating of the at least one sparsity map comprises generating multiple sparsity maps to represent the sparsity pattern within multiple groups of the weights; and
the storing of the at least one sparsity map comprises storing the multiple sparsity maps and the compressed weights in a manner that arranges each sparsity map to occupy columns that are adjacent to columns that store the compressed weights corresponding to the sparsity map.

Example 14: The method of any one of examples 11 to 13, further comprising:
causing at least one of the multiplication-accumulation units to be bypassed based on the at least one sparsity map indicating that at least one weight that corresponds to the at least one of the multiplication-accumulation units has a value equal to zero.

Example 15: A memory device comprising:
a memory array comprising at least one bank, the at least one bank configured to store weights associated with a machine-learned model, the weights having a first numerical data type;
at least one logic circuit coupled to the at least one bank and comprising multiplication-accumulation units, the logic circuit configured to perform, using the multiplication-accumulation units, processing-in-memory to implement at least a portion of the machine-learned model; and
one or more of the following:
   at least one type converter configured to generate converted weights by converting the weights from the first numerical data type to an expected input data type associated with the multiplication-accumulation units;
   at least one zero-activation skipping filter coupled to the at least one logic circuit and configured to perform input-based sparsity handling to cause operations performed by the multiplication-accumulation units to be bypassed based on a data element of input data having a value equal to zero; or
   at least one weight-based sparsity filter coupled between the memory array and the multiplication-accumulation units and configured to perform weight-based sparsity handling to cause an operation performed by a multiplication-accumulation unit to be bypassed based on a corresponding weight having a value equal to zero.

Example 16: The memory device of example 15, wherein:
the first numerical data type is associated with a first quantity of bits; and
the expected input data type is associated with a second quantity of bits that is greater than the first quantity of bits.

Example 17: The memory device of example 15 or 16, wherein:
the memory device comprises the at least one zero-activation skipping filter; and
the at least one zero-activation skipping filter is configured to:
   receive the input data having multiple data elements, the multiple data elements including a first portion of data elements having non-zero values and a second portion of the data elements having values equal to zero;
   generate filtered input data that includes the first portion of the data elements; and
   pass the filtered input data to multiplication-accumulation units of the memory device.

Example 18: The memory device of any one of examples 15 to 17, wherein:
the memory device comprises the at least one weight-based sparsity filter and a data compressor;
the data compressor is configured to:
   receive the weights, the weights having a sparsity ratio that causes a first portion of the weights to have non-zero values and causes a second portion of the weights to have values equal to zero;
   generate compressed weights that include the first portion of weights;
   pass the compressed weights to the memory array;
   generate at least one sparsity map to represent a sparsity pattern of the weights; and
   pass the at least one sparsity map to the memory array; and
the memory array is configured to:
   store the compressed weights within a row; and
   store the at least one sparsity map.

Example 19: The memory device of example 18, wherein the memory array is configured to store the at least one sparsity map in the same row as the compressed weights.

Example 20: The memory device of example 18 or 19, wherein:
the memory device includes the at least one type converter; and
the at least one weight-based sparsity filter is configured to receive the converted weights from the at least one type converter.

What is claimed is:

1. A method performed by a memory device, the method comprising:
performing, using multiplication-accumulation units of the memory device, processing-in-memory to implement at least a portion of a machine-learned model, the performing comprising:
storing, within the memory device, weights associated with the machine-learned model, the stored weights having a first numerical data type;
generating converted weights by converting the weights from the first numerical data type to an expected input data type associated with the multiplication-accumulation units; and
passing the converted weights as inputs to the multiplication-accumulation units.

2. The method of claim 1, wherein:
the first numerical data type is associated with a first quantity of bits; and
the expected input data type is associated with a second quantity of bits that is greater than the first quantity of bits.

3. The method of claim 1, wherein:
the first numerical data type is associated with a first level of precision; and
the expected input data type is associated with a second level of precision that is greater than the first level of precision.

4. The method of claim 1, wherein the performing of the processing-in-memory further comprises:
passing input data to the multiplication-accumulation units, the input data representing at least one input of the machine-learned model, the input data having a second numerical data type that matches the expected input data type associated with the multiplication-accumulation units.

5. The method of claim 1, wherein:
the weights are associated with a sparsity ratio, the sparsity ratio causing a first portion of the weights to have non-zero values and causing a second portion of the weights to have values equal to zero;
the storing comprises storing a set of the weights within a row of a memory array of the memory device; and
the method further comprises:
generating compressed weights that include the first portion of weights;
storing the compressed weights as the set of weights within the row;
generating at least one sparsity map to represent a sparsity pattern of the weights; and
storing the at least one sparsity map within the memory array.

6. The method of claim 5, wherein the storing of the at least one sparsity map comprises storing the at least one sparsity map in the same row as the set of weights.

7. The method of claim 6, wherein:
the generating of the at least one sparsity map comprises generating multiple sparsity maps to represent the sparsity pattern within multiple groups of the weights; and
the storing of the at least one sparsity map comprises storing the multiple sparsity maps and the set of the weights in a manner that arranges each sparsity map to occupy columns that are adjacent to columns that store the compressed weights corresponding to the sparsity map.

8. The method of claim 5, further comprising:
causing at least one of the multiplication-accumulation units to be bypassed based on the at least one sparsity map indicating that at least one weight that corresponds to the at least one of the multiplication-accumulation units has a value equal to zero.

9. A method performed by a memory device, the method comprising:
performing, using multiplication-accumulation units of the memory device, processing-in-memory to implement at least a portion of a machine-learned model, the performing comprising at least one of the following:
performing input-based sparsity handling to cause operations performed by the multiplication-accumulation units to be bypassed based on a data element of input data having a value equal to zero; or
performing weight-based sparsity handling to cause an operation performed by a multiplication-accumulation unit of the multiplication-accumulation units to be bypassed based on a corresponding weight having a value equal to zero, the corresponding weight associated with the machine-learned model.

10. The method of claim 9, wherein:
the performing of the processing-in-memory comprises performing the input-based sparsity handling; and
the performing of the input-based sparsity handling comprises:
receiving, by a zero-activation skipping filter of the memory device, the input data having multiple data elements, the multiple data elements including a first portion of data elements having non-zero values and a second portion of the data elements having values equal to zero;
generating filtered input data that includes the first portion of the data elements; and
passing the filtered input data to multiplication-accumulation units of the memory device.

11. The method of claim 9, wherein:
the performing of the processing-in-memory comprises performing the weight-based sparsity handling; and
the performing of the weight-based sparsity handling comprises:
receiving, by a data compressor of the memory device, weights associated with the machine-learned model, the weights having a sparsity ratio that causes a first portion of the weights to have non-zero values and causes a second portion of the weights to have values equal to zero;
generating, by the data compressor, compressed weights that include the first portion of weights;
storing the compressed weights within a row of a memory array of the memory device;
generating, by the data compressor, at least one sparsity map to represent a sparsity pattern of the weights; and
storing the at least one sparsity map within the memory array.

12. The method of claim 11, wherein the storing of the at least one sparsity map comprises storing the at least one sparsity map in the same row as the compressed weights.

13. The method of claim 12, wherein:
the generating of the at least one sparsity map comprises generating multiple sparsity maps to represent the sparsity pattern within multiple groups of the weights; and
the storing of the at least one sparsity map comprises storing the multiple sparsity maps and the compressed weights in a manner that arranges each sparsity map to occupy columns that are adjacent to columns that store the compressed weights corresponding to the sparsity map.

14. The method of claim 11, further comprising:
causing at least one of the multiplication-accumulation units to be bypassed based on the at least one sparsity map indicating that at least one weight that corresponds to the at least one of the multiplication-accumulation units has a value equal to zero.

15. A memory device comprising:
a memory array comprising at least one bank, the at least one bank configured to store weights associated with a machine-learned model, the weights having a first numerical data type;
at least one logic circuit coupled to the at least one bank and comprising multiplication-accumulation units, the logic circuit configured to perform, using the multiplication-accumulation units, processing-in-memory to implement at least a portion of the machine-learned model; and
one or more of the following:
at least one type converter configured to generate converted weights by converting the weights from the first numerical data type to an expected input data type associated with the multiplication-accumulation units;
at least one zero-activation skipping filter coupled to the at least one logic circuit and configured to perform input-based sparsity handling to cause operations performed by the multiplication-accumulation units to be bypassed based on a data element of input data having a value equal to zero; or
at least one weight-based sparsity filter coupled between the memory array and the multiplication-accumulation units and configured to perform weight-based sparsity handling to cause an operation performed by a multiplication-accumulation unit to be bypassed based on a corresponding weight having a value equal to zero.

16. The memory device of claim 15, wherein:
the first numerical data type is associated with a first quantity of bits; and
the expected input data type is associated with a second quantity of bits that is greater than the first quantity of bits.

17. The memory device of claim 15, wherein:
the memory device comprises the at least one zero-activation skipping filter; and
the at least one zero-activation skipping filter is configured to:
receive the input data having multiple data elements, the multiple data elements including a first portion of data elements having non-zero values and a second portion of the data elements having values equal to zero;
generate filtered input data that includes the first portion of the data elements; and
pass the filtered input data to multiplication-accumulation units of the memory device.

18. The memory device of claim 17, wherein:
the memory device comprises the at least one weight-based sparsity filter and a data compressor;
the data compressor is configured to:
receive the weights, the weights having a sparsity ratio that causes a first portion of the weights to have non-zero values and causes a second portion of the weights to have values equal to zero;
generate compressed weights that include the first portion of weights;
pass the compressed weights to the memory array;
generate at least one sparsity map to represent a sparsity pattern of the weights; and
pass the at least one sparsity map to the memory array; and
the memory array is configured to:
store the compressed weights within a row; and
store the at least one sparsity map.

19. The memory device of claim 18, wherein the memory array is configured to store the at least one sparsity map in the same row as the compressed weights.

20. The memory device of claim 18, wherein:
the memory device comprises the at least one type converter; and
the at least one weight-based sparsity filter is configured to receive the converted weights from the at least one type converter.
